(19) United States
(12) Patent Application Publication
(10) Pub. No.: US 2010/0159324 A1
(43) Pub. Date: Jun. 24, 2010

(54) LITHIUM POWDERS FOR BATTERIES

(75) Inventors: Daniel H. Irvin, Fulshear, TX (US); Zhenhua Mao, Ponca City, OK (US)

Correspondence Address: ConocoPhillips Company - IP Services Group;Attention: DOCKETING, 600 N. Dairy Ashford, Bldg. MA-1135, Houston, TX, 77079, US

(73) Assignee: CONOCOPHILLIPS COMPANY, Houston, TX (US)

(21) Appl. No.: 12/339,796

(22) Filed: Dec. 19, 2008

(51) Int. Cl. H01M 4/00; H01M 4/58; H01M 4/86

(52) U.S. Cl. 429/220; 429/231.5; 252/182.1

(57) ABSTRACT

This invention relates to lithium-ion batteries and cathode powders for making lithium-ion batteries where the cathode powder comprises a blend or mixture of at least one lithium transition metal poly-anion and with one or more lithium transition-metal oxide powders. A number of different lithium transition-metal oxides are suitable, especially formulations that include nickel, manganese and cobalt. The preferred lithium transition metal poly-anion is carbon-containing lithium vanadium phosphate. Batteries using the mixture or blend of these powders have been found to have high specific capacity, especially based on volume, high cycle life, substantially improved safety issues as compared to lithium transition-metal oxides, per se, and an attractive electrode potential profile.

### CROSS-REFERENCE TO RELATED APPLICATIONS

None.

### STATEMENT REGARDING FEDERALLY SPONSORED RESEARCH OR DEVELOPMENT

None

### FIELD OF THE INVENTION

This invention relates to materials for use in the positive electrode of lithium-ion batteries and processes for making such materials.

### BACKGROUND OF THE INVENTION

Lithium-ion batteries are recognized and valued for high efficiency, energy density, high cell voltage and long shelf life and have been in commercial use since the early 1990's. As always though, there is a desire to make better batteries for less cost.

A conventional lithium ion battery includes an anode, a separator, a cathode, and a liquid electrolyte that fills pore spaces within all of the three components. The anode and cathode materials are generally metallic foils with electrode materials adhering to the foils in electrical connection thereto which take up and release lithium ions as the battery is discharged and is recharged. The electrode material on the anode is generally provided in the form of a powder that is applied to the anode foil with a binder and such powders are generally carbonaceous powders, lithium alloying metals, and metal oxides. The electrode material on the cathode is also a powder and generally includes a lithium bearing compound that is able to release and take up lithium ions.

While all of the components of a lithium ion battery provide opportunities for improved performance, there has been particular effort for improving the cathode powders. Indeed, using either lithium cobalt oxide or lithium nickel oxide in a battery will yield a high performance battery, but the safety concerns related to overheating and cathode decomposition that would release oxygen when overheated such as during over recharging or fast discharge such as being short-circuited have discouraged commercial implementation of these materials. Iron, cobalt, and manganese powders along with combinations of these elements have been proposed along with other transition metals. While many materials are certainly active for use as a cathode powder, each seems to excel in one or two performance parameters but have trade-offs or other limitations such as safety considerations that has prevented a single cathode chemistry from being the clear choice for broad lithium-ion battery use. There is likely to be a very large payoff for an optimal performing battery system that can be provided at low or reasonable cost and usable in a wide range of environments when considering the future for batteries in electric powered or hybrid automobiles. An optimal performing battery will have high energy density, long cycle life, high power capability or energy efficiency, and a high safety margin. These areas are the subject of most technical efforts for battery improvements. Such improvements will most likely come from improvements in electrode materials and in cell design.

### BRIEF DESCRIPTION OF THE DRAWINGS

The invention, together with further advantages thereof, may best be understood by reference to the following description taken in conjunction with the accompanying drawings in which:

FIG. 1 is graph plotting the cell voltage compared to specific capacity of cells made from certain cathode materials;

FIG. 2 is graph plotting the cell voltage compared to specific capacity of a cell made of a composite cathode material constituting an example of the invention;

FIG. 3A is a graph plotting capacity retention of two different cells compared to a predicted capacity retention related to the number of charge and discharge cycles;

FIG. 3B is a graph plotting capacity retention of several different cathode compositions related to the number of charge and discharge cycles;

FIG. 4 is a graph showing the total capacity loss of a cell related to the number of charge and discharge cycles;

FIG. 5 is a graph showing the energy efficiency of a cell related to the number of charge and discharge cycles;

FIG. 6 is a second graph showing the energy efficiency of a cell related to the number of charge and discharge cycles;

FIG. 7 is a graph showing differential scanning calorimetry plots indicating the heat emitted by cathode materials when heated charged to 4.2 volts and subjected to certain temperatures;

FIG. 8 is a second graph showing differential scanning calorimetry plots indicating the heat emitted by cathode materials when charged to 4.4 volts and subjected to certain temperatures;

FIG. 9 is a third graph showing a single differential scanning calorimetry plot indicating the heat emitted by a composite cathode material when charged to 4.4 volts and subjected to certain temperatures;

FIG. 10 is an image from a scanning electron microscope for a cathode comprising a single chemistry material;

FIG. 11 is a second image from a scanning electron microscope for a cathode comprising particles where a first set of particles has a first chemistry and the second set of particles having a distinctly different chemistry and the first and second particles are mixed or blended together as a composite;

FIG. 12 is a block diagram for a technique for synthesizing LVP;

FIG. 13 is a block diagram for an alternative technique for synthesizing LVP;

FIG. 14 is a block diagram for making CLVP from the synthesized LVP shown in FIGS. 12 or 13;

FIG. 15 is a block diagram for a preferred process of synthesizing CLVP;

FIG. 16 is a graph showing the cell voltage profiles of the first and tenth cycles of example materials for use as cathode material in a cell;

FIG. 17 is a graph showing the cell voltage profiles of the first and tenth cycles of example inventive composite cathode materials;

FIG. 18 is a graph showing specific capacity and capacity retention for cells related to charge and discharge cycles;

FIG. 19 is a graph showing a comparison of the cell voltage profiles of the first and fortieth cycles of another example of materials for use as cathode material in a cell;

FIG. 20 is a graph showing a comparison of the cell voltage profiles of the first and forty-fifth cycles of another example inventive composite cathode materials in a cell;

FIG. 21 is a graph showing the average cell voltage for the charging and discharging of materials relative to the number of charge and discharge cycles for several materials that may be used as cathode material in a cell;

FIG. 22 is a graph showing the energy efficiencies at different cycle numbers for inventive composite cathode materials in a cell;

FIG. 23 is a graph showing the cell voltage profiles of the first and tenth cycles of another example of materials for use as cathode material in a cell;

FIG. 24 is a graph showing the cell voltage profiles of the first and tenth cycles of another example of inventive materials for use as cathode material in a cell;

FIG. 25 is a graph showing specific capacity and capacity retention of different cathode materials relative to cycle number;

FIG. 26 is a graph showing capacity loss comparison between an inventive and non-inventive materials for use as a cathode material in a cell relative to cycle number;

FIG. 27 is a graph showing a comparison of cell voltage profiles between the tenth and forty-fifth cycles for an example of cathode materials when cycled between 3 and 4.4 volts;

FIG. 28 is a graph showing a comparison of cell voltage profiles between the tenth and forty-fifth for an example of inventive materials when cycled between 3 and 4.4 volts;

FIG. 29 is a graph showing a comparison of the average cell voltages on charge and discharge and round-trip energy efficiencies at different cycle numbers for electrodes based on inventive and non-inventive cathode materials when the cells were cycled between 3 and 4.4 volts;

FIG. 30 is a graph showing a comparison of the DSC patterns for electrodes made by single and composite materials where the cells were pre-charged to 4.2 volts;

FIG. 31 is a graph showing a comparison of the DSC profiles for electrodes made from the single and composite cathode materials that were charged to 4.4 volts

FIG. 32 is a graph showing the high DSC profiles of a single LMO cathode materials where the electrodes were charged to 4.2 and 4.4 volts;

FIG. 33 is a graph showing the lowered DSC profiles of the inventive composite cathode materials where the electrodes were charged to 4.2 and 4.4 volts;

FIG. 34 is a graph showing the cell voltage profiles on the first and fifteenth cycles for another example of the composite cathode materials in an electrode;

FIG. 35 is a graph showing the specific capacities and capacities retentions at different cycle numbers for the inventive composite electrodes;

FIG. 36 is a graph showing the net capacity loss and the ratio of the net capacity loss of the mixture or composite electrode to that of a single material electrode at different cycle numbers; and

FIG. 37 is a graph showing a comparison of the specific capacities at different cycle numbers for an additional single LMO sample and an inventive composite sample using the same LMO in the electrodes and the ratio of net capacity losses.

### DETAILED DESCRIPTION OF THE INVENTION

The description, discussion and understanding of the invention, as it relates to various parameters and qualities for batteries, will be aided by setting forth several definitions. As used herein, the terms are intended to have their usual meanings in the art but for clarity, the specific definitions are provided to avoid confusion and aid in clear understanding.

A “cell” is the basic electrochemical unit used to store and release electrical energy.

A “battery” is two or more electrochemical cells electrically interconnected in an appropriate series/parallel arrangement to provide the required operating voltage and current levels. Under common usage, the term “battery” is also applied to a single cell device.

The “cathode” is the positive electrode of a cell.

“Energy Density” is the electric energy available in a charged cell per unit weight (Wh/kg) or pre unit volume (Wh/L). “Specific Capacity” is another term meaning the same characteristic in the units of mAh/g or mAh/cc.

“Capacity Fade” or “Fading” is the gradual loss of capacity of a rechargeable battery with cycling. These terms are also synonymous with “Capacity Loss”

“Coulombic Efficiency (%)” is the ratio of the amount of electrical charge discharged from an electrode material to the amount of electrical charge used to charge the electrode to the state before discharge.

“Cycle Life” is typically defined as the number of charge and discharge cycles required to reduce the capacity of a cell below a certain percentage of its initial value.

“Electrode Potential” is the electrical voltage between the electrode of interest and another electrode (reference electrode).

“Power” means energy released per unit time

“Thermal stability” means chemical and physical behavior of a material as a function of temperature.

“Stabilization” is a process which renders particles of a carbon-residue-forming material (CRFM) infusible such that the surface of the CRFM particles does not soften or melt and fuse to adjacent CRFM particles during subsequent heat treatments as long as the temperature of the subsequent heat treatment does not exceed the instantaneous melting point of the stabilized CRFM.

“Carbonization” is a thermal process that converts a carbon containing compound to a material that is characterized as being “substantially carbon”. “Substantially carbon”, as used herein, indicates that the material is at least 95% carbon by weight.

A “carbon-residue-forming material” (CRFM) is any material which, when thermally decomposed in an inert atmosphere to a carbonization temperature of 600° C. or an even greater temperature, forms a residue which is “substantially carbon”.

Turning now more specifically to the invention, the inventors have been working to overcome the problems noted above regarding cathode powders made from lithium and an oxide of a transition metal (“LMO”) by working with newer cathode chemistries specifically including lithium transition metal polyanionic compounds (“LMP”) such as lithium metal phosphate compounds. The transition metals for the LMOs and the LMPs are preferably first row transition metals selected from the scandium, titanium, vanadium, chromium, manganese, iron, cobalt, nickel, copper, zinc or a combination thereof. Like the LMO's, the LMP's have been explored by a number of firms seeking the best performance characteristics. One particular known LMP is lithium vanadium phosphate (“LVP”) with the stoichiometric composition of Li₃V₂(PO₄)₃. The inventors prefer LVP powders or materials that contain carbon or are coated with carbon.

In comparison to the description here of carbon containing, it is known that many other cathode powders have electrically conductive particles such as carbon black and graphite, etc. added so as to improve the electrical conductivity. However, until the cathode powder is applied to the metallic cathode foil by a binder, the conductive additive carbon particles are not bound to the cathode powder. It is believed that the carbon being bound to the cathode powder particles in the process of making the cathode powder makes the powder better in that the conductivity is inherent in all, or substantially all of the particles of the powder. The conductive additive carbon particles in other systems are only connected to the particles of the cathode powder by the binder used to apply the cathode powder to the metallic cathode foil.

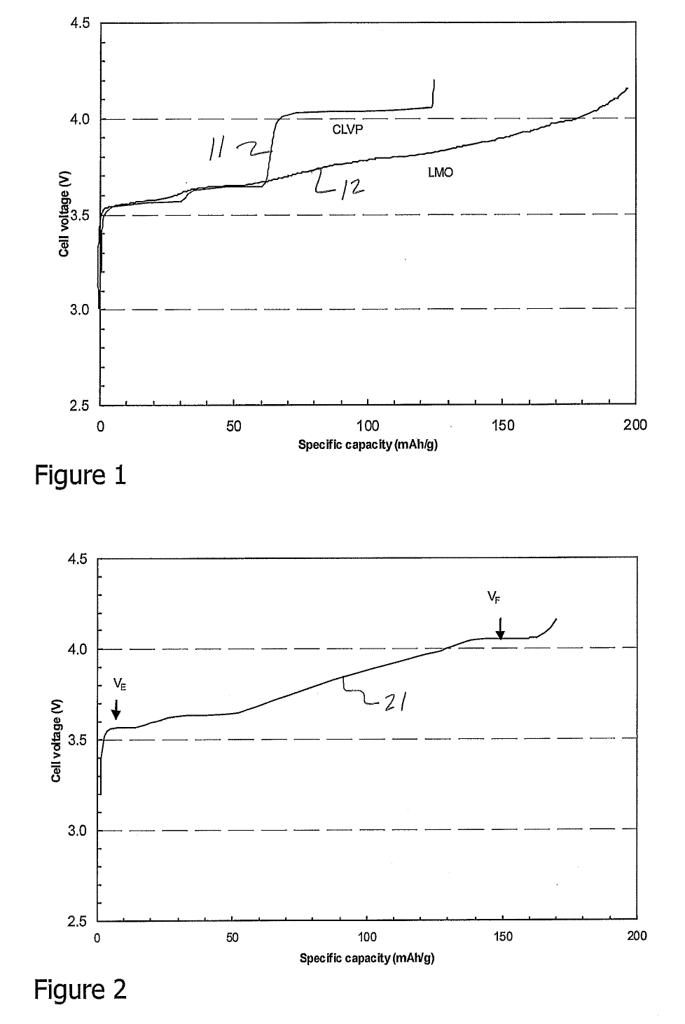

This carbon containing LVP is hereafter called CLVP and is preferred because it has high power capability, cycle life, thermal stability and it has distinct voltage plateaus near the fully charged and near the fully discharged state. Specifically, CLVP has three distinct voltage plateaus and a plateau is basically a substantially constant discharge voltage over a specific capacity of at least 10 mAh/g. The inventors also prefer CLVP within a certain particle size distribution as will be described below. The three charge plateaus are easily seen in FIG. 1 where line 11 indicates the electrode potential profile for CLVP. These charge plateaus are quite beneficial for battery system manufacturers in that these plateaus can be easily detected by simple electronic systems that then provide a reliable indication to the user of the charge status of the battery system. Clearly, a simpler electronic system is preferred for cost and other considerations.

The CLVP is more particularly described in US patent applications having the Ser. Nos. 12/024,023 and 12/024,038. For all purposes, the disclosures of U.S. patent application Ser. Nos. 12/024,023 and 12/024,038 are incorporated by reference herein. A more thorough description of CLVP and the process for producing the same is set forth below, but not in the same detail as in the above referenced patent applications.

### High Energy Density

Also shown in FIG. 1 is line 12 indicating the electrode potential profile for a conventional LMO. The profile is a generally smooth curve that extends to a higher specific capacity than the LMP material. Specific capacity is the measure of what is more easily understood as energy density. LMOs are simply able to hold more electric charge per weight and per volume than LMPs and CLVP and therefore a battery made of LMO can be smaller and lighter for a specified application. In applications such as electric powered vehicles, the battery packs would be smaller and lighter and would inherently improve the electric efficiency of such vehicles. What the inventors have discovered, to their surprise, is that blending an LMP with one or more LMO's produces batteries that are better than batteries made with either LMP or LMO alone. More specifically, the energy density of the blended material is close to that of an LMO based battery while having other performance characteristics that are superior to LMO based batteries. More importantly, however, the overall performance of the blended material appears to be substantially better than what should be expected by simply adding the inherent qualities of the contributing materials (i.e. LMO and LMP) in the blended ratio. These enhanced qualities can include cycle life, specific capacity, energy density, energy efficiency and thermal stability. Referring to FIG. 2, line 21 indicates an electrode potential profile for a conventional LMO with CLVP showing both high energy density with the desirable charge plateaus.

### Long Cycle Life

As mentioned above, it would be desirable to develop an LMO based lithium-ion battery with long cycle life. A lithium-ion battery using a mixture of CLVP and LMO as the cathode material, in addition to having a high energy density has improved cycle life over a battery using the same LMO in its pure form or without CLVP blended in. Blending in a measure of CLVP dramatically increases cycle life.

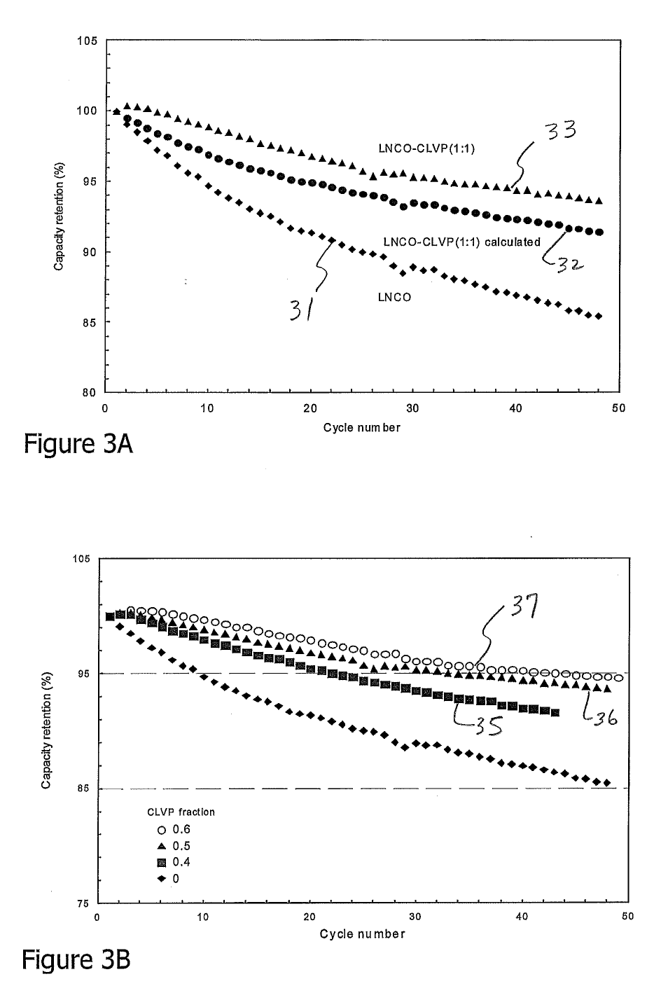

Referring to FIG. 3A, the retained energy density or retained specific capacities are shown for an LMO, specifically a lithium nickel cobalt oxide that will be described in the examples, along with various blends of the LMO with CLVP. The series of points identified by the number 31 indicates the retained specific capacity of a pure LMO after a series of charge and discharge cycles where approximately 85% of the original capacity is retained after about 50 cycles. In comparison, the CLVP retains approximately 100% of it specific capacity after 50 cycles. Simple algebra suggests that the series of points identified by the number 32 would be the resulting retained capacity of a 50/50 blend by weight of the LMO and CLVP. However, the measured retained specific capacity is indicated by the series of points identified by the number 33 which is clearly above the series 32 and indicates longer cycle life for the blended material than would expected.

Moreover, the better than expected improvement in retained specific capacity is not limited to 50/50 blends. Referring to FIG. 3B, the series of points identified by the numbers 35, 36, and 37 indicate retained capacity for blends having 40%, 50% and 60% CLVP mixed with the LMO.

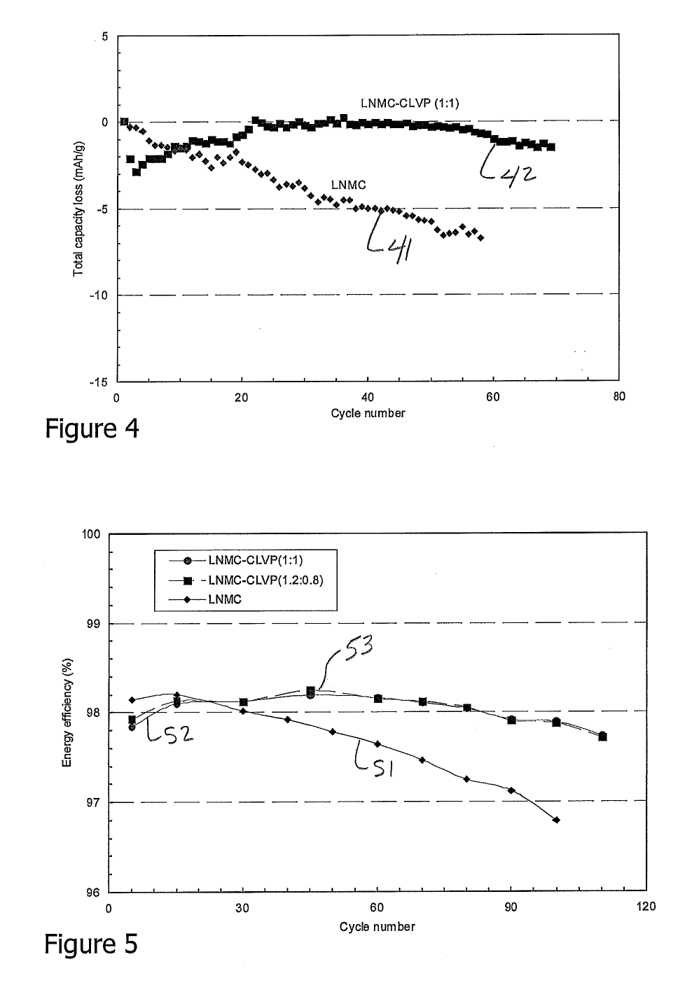

FIG. 4 provides a similar differentiation for another LMO, this time a lithium nickel manganese cobalt oxide that will also be described with the examples. After 60 charge and discharge cycles, the LMO has lost about 7 mAh/g of capacity while the 50/50 blend has lost less than 2 mAh/g. It should also be recognized from the relative trajectories of the series of points indicated by the numbers 41 and 42 that the cycle life of the LMO will be considerably less than the blend of the LMO with CLVP.

### High Energy Efficiency

Coulombic energy efficiency, as defined earlier, is a measure of the amount of electrical energy that is available for a discharge cycle related to the amount energy used to charge the electrode in anticipation of the discharge cycle. A highly efficient battery or cell will give back a very high percentage of the energy stored in the battery or cell while a less efficient cell will only give back a smaller portion of the energy that was delivered to the cell.

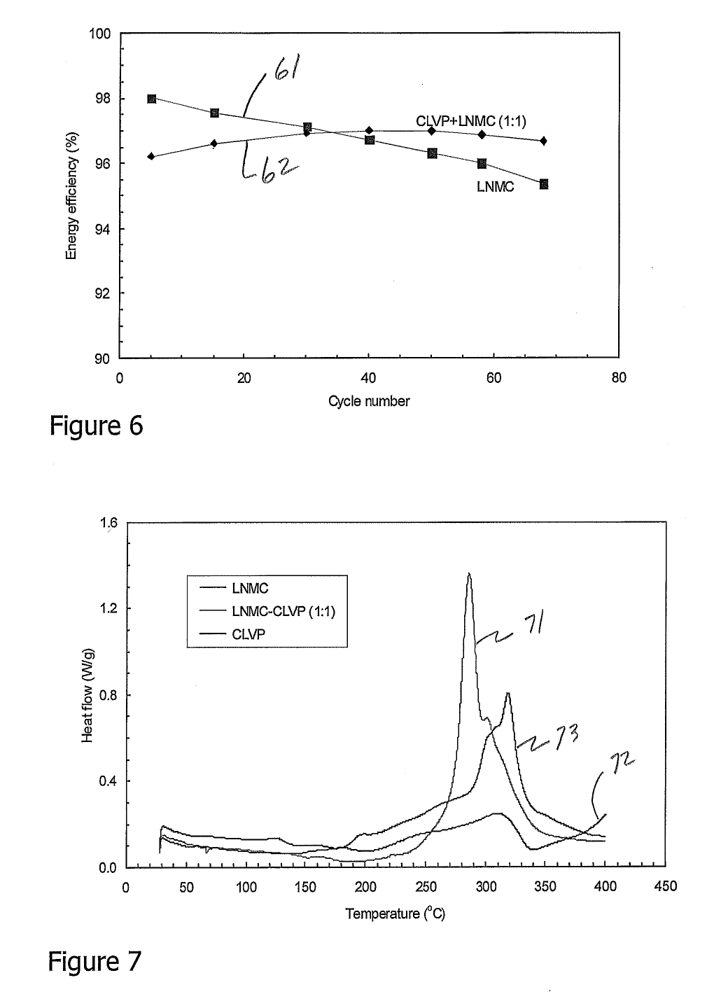

Referring now to FIG. 5, it can bee seen that cells are highly efficient for their first few cycles discharging above 98% of the energy delivered to the cells. However, in addition to the total amount of energy stored diminishing as the number of cycles increase, the efficiency diminishes more rapidly for the pure LMO cells as compared with the cells made of LMO blended or mixed with CLVP. Line 51, indicating the efficiency of the pure LMO cell is clearly on a downward trajectory as compared with lines 52 and 53, showing the efficiency of the 50/50 blended composite cell along with a 60/40 LMO to CLVP cell. Referring to FIG. 6, a similarly flat line 62 for the blended material stands in contrast to the descending line 61 indicating the efficiency of the pure LMO cell. As noted above, there is a lot of interest in developing battery technology for electric vehicles. If a vehicle is expected to be recharged every evening, a cycle life for a battery pack will need to perform for at least two or three years to be potentially acceptable in the market place. With diminishing efficiency, the recharge is less effective and the range of the vehicle will diminish over the life of the battery.

### Improved Safety

Safety was previously mentioned and is a little harder to quantify as there are a number of aspect involved with battery safety. However, focusing primarily on the safety issue that is most relevant to LMO cells is what happens in the event the cell becomes significantly heated. Such heating episodes can occur during rapid discharge, overcharging or possibly the battery could be exposed to high temperatures as the result of a fire at a vehicle accident seen. LMO cells are known to decompose and release heat at temperatures above 200° C. and also to release oxygen as part of the decomposition process. These characteristics are definitely not preferred. The resulting oxygen gas may instantaneously react with organic solvents in electrolyte potentially causing catastrophic damage to the battery and things around the battery.

Blending CLVP with LMO offers at least two benefits for improved cell safety over a pure LMO cell. First, the amount of LMO in the electrode is proportionally reduced, so the total amount of heat that may possibly released from the LMO is reduced. Not only is the LMO diluted where one particle of LMO is less able to heat another LMO particle while decomposing, the total LMO mass and the total amount of potential heat release is reduced. Secondly, the CLVP may absorb oxygen gas because the vanadium atoms in CLVP are not fully oxidized and would be easily oxidized by oxygen gas to form vanadium oxide. Therefore, the CLVP at least partially neutralizes one of the destructive hazards of LMO reducing the likelihood or severity of a runaway reaction of the cell at very high temperatures. Other design and control safeguards for cell and battery design may further alleviate the safety hazards posed by LMO electrodes.

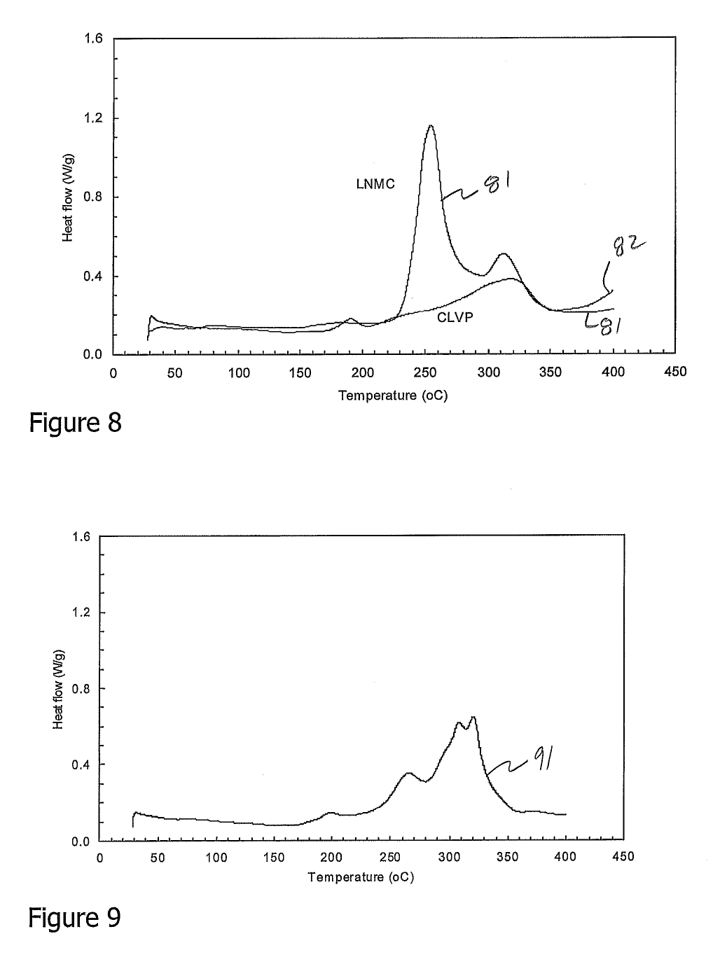

Referring to FIG. 7, the heat flow from a cell is measured where line 71 indicates the heat released by a pure LMO cell, in this case the LMO material is lithium nickel manganese cobalt oxide that is described in the examples, at various temperatures. It should be seen that at a temperature above 250° C., the heat emission or heat flow rapidly increases indicating a substantial release of energy and considerable decomposition. Line 72 indicates a very limited heat emission from a pure CLVP cell with a relative minor emission at about 300° C. The composite blended CLVP and LMO material emits heat at elevated temperature as indicated by the line 73, but the heat release is significantly less than the pure LMO cell and is shifted to a high temperature before the heat is released. FIG. 7 provides information for a cell fully charged to 4.2 volts. In FIGS. 8 and 9, the cells are charged to a higher charge of 4.4 volts.

Turning to FIG. 8, what should be seen is that the line 81 indicates that the higher charge on the pure LMO cell lowers the temperature at which the substantial heat release begins. While the peak heat release appears to be higher for the lower charged cell, the two peaks are comparable to one another and quite high. The line 82 is similar to the line 72 in FIG. 7. However, turning to FIG. 9 where line 91 indicates the heat release of a CLVP and LMO blended cell, again the total heat release and the peak heat release is less and the temperature at which the significant heat release begins is at a much higher temperature.

### LMO Materials

As mentioned earlier, there is a broad array of suitable LMO materials. Basically any oxide of a first row transition metal basically including the group of scandium, titanium, vanadium, chromium, manganese, iron, cobalt, nickel, copper, zinc or a combination of two or more such transition metals. Having extra transition metals of other materials included should impair the suitability of the LMO component of the blended cathode material. For example, lithium cobalt oxide and lithium nickel oxides are well known for their high energy density. LiNi_{1/3}Co_{1/3}Mn_{1/3}O₂ (LNMC) is generally recognized as a fairly stable LMO. Efforts to further stabilize LNMC materials for high voltage use have surface coating with inorganic compounds such as AlF₃ or LiC₂O₄BF₂ and by doping other elements such as strontium and fluoride as well as other treatments. Applicants generally prefer compounds with nickel and/or cobalt with or without manganese.

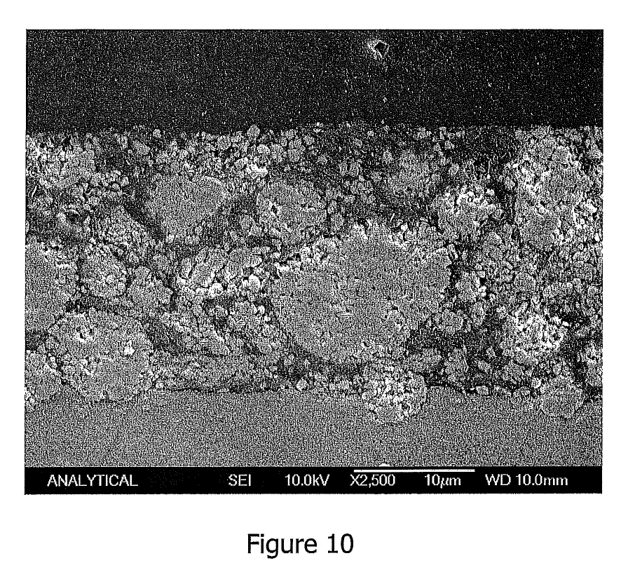

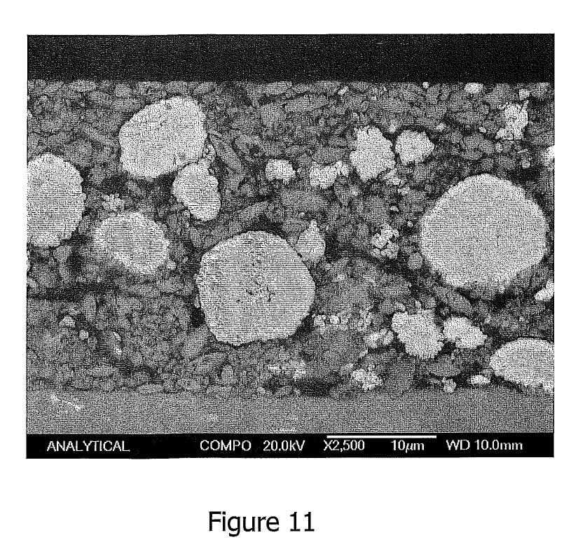

Applicants have much more focused preferences for the LMP component. Applicants prefer CLVP as at least part of the LMP component and will sometimes refer to the LMP component as the CVLP component of the composite cathode material. Referring to FIGS. 10 and 11, scanning electron microscope images are presented where a pure LNMC cell is densely pack with LNMC particles in the more whitish hue with the dark binder holding the mass to the metallic foil at the bottom of the picture. In comparison, the whitish LNMC particles in FIG. 11 are less dense and dispersed by the gray CLVP particles and the dark binder. One should note that the CLVP particles are smaller than the LNMC particles. Small particles are generally preferred, especially in high power environments to provide high surface area and therefore, high accessibility for the lithium to intercalate and de-intercalate from the transition metal oxide. However, the manufacturing technology for LMOs is not suited to provide the small particle size that is possible with CLVP technology. Moreover, having the small CLVP particle size physically is more likely to provide the LMO particles more space to expand and contract, however slightly as the lithium enters and exits the structure. Such expansion and contraction is believed to cause the abbreviated cycle life of the LMO and as such, the CLVP actually aids the LMO to retain its physical integrity and extend the life of each particle. The preferred particle size of the CLVP is from about 0.1 micron to about 15 microns with an averaging about 2 microns. By comparison the LMO particles are about 1-30 microns with an average larger than the CLVP particles and the CLVP particles are more dimensionally stable during charge and discharge cycling. Thus, with these small particles uniformly distributed in the electrode structure with the larger particles, the resulting mechanical integrity of the electrode would likely be much more stable than that of only LMO electrodes. As lithium ions are intercalated into and de-intercalated from the cathode particles, the particles often expand and contract. It is known that deterioration in mechanical integrity contributes significantly to the capacity fading of a battery during cycling and since LMO has a shorter cycle life, must expand and contract more substantially than CLVP. The expansion and contraction is believed to cause the structural deterioration and therefore cause a short cycle life. With such an electrode design, the more stable and smaller sized CLVP particles reduce the number of adjacent LMO particles that each LMO particle must press against thereby reducing structural deterioration and thus increasing the cycle life of the blended or mixed powder. Thus, two beneficial effects on the cycle life can be obtained by blending CLVP with LMO: i) direct reduction in the capacity loss and ii) stabilization in the mechanical integrity of the electrodes.

The LiNi_{0.8}Co_{0.2}O₂ powders for the Examples were synthesized as follows: The precursors were Ni(OH)₂, LiNO₃, and LiCoO₂. The precursors were mixed with the desired stoichiometric composition and ground by ball-milling. The resulting mixtures were placed in a tube furnace and heated in nitrogen gas environment with the following sequences: at 300° C. for 2 hours, 400° C. for 2 hours, and 600° C. for 12 hours. After the powders were cooled to ambient temperature, they were ground by ball-milling, placed back into the furnace, and heated at 610° C. in nitrogen gas for 15 hours. The resulting powders were further heated in air with some variations for different batches: at 675° C. for 15 hours for the first LiNi_{0.8}Co₂O₂ powder, and at 700° C. for 15 hours for the second LiNi_{0.8}Co₂O₂ powder. After the heat treatment in air, the powders were ground with a mortar and pestle before use.

### CLVP Materials

Applicants are aware of three basic techniques for producing CLVP and any of these or other techniques for providing CLVP would be suitable. The first is to obtain LVP from a solid state reaction which essentially comprises precursors of a lithium-containing compound, one or more vanadium oxide compounds, and a phosphoric acid containing compound. Preferably, the lithium-containing compound is a lithium salt and the phosphoric acid compound is a phosphoric acid salt. The precursor compounds are intimately mixed and then heated to conduct a reaction whereby the lithium, vanadium and phosphate combine to form the Li₃V₂(PO₄)₃. The resulting LVP powder is then preferably subjected to a precipitation coating procedure generally described for a carbon particle in U.S. Pat. No. 7,323,120 issued Jan. 29, 2008. The coating process generally comprises providing a first solution of dissolved carbon-residue-forming material, wherein the first solution comprises one or more solvents and the carbon-residue-forming material. The powder is suspended in the first solution and a second fluid is added to the first solution that causes the carbon-residue-forming material to selectively precipitate on the fine LVP particles. The coated particles are removed from the solution by conventional means, such as filtration, and subjected to heat treatments to carbonize the coating. With the carbon coating, the particles are electrically conductive which is believed to work well with the LMO material so that not only the lithium ions may move through the cathode material, but the electrons may move through the cathode material as the cell is charged and discharged. The heat treatment of the carbon coating is conducted in an inert atmosphere at a temperature of at least 850° C.

The second and third techniques for producing CLVP that is suitable as a component of the blended cathode material include solution synthesizing techniques. Applicants believe liquid solution techniques are preferred as a higher percentage of precursor material ends up in the final product and the process may be more easily steered to provide smaller particle sizes. Also, especially for the third basic technique, the liquid synthesis process works quite well with the carbon coating or carbon depositing process.

The second basic technique for producing CLVP begins with forming a suspension of the precursors with a high boiling temperature solvent and driving the reaction to form the desired LVP product in liquid solution. The reaction occurs at temperatures above about 50° C. up to about 400° C., although a maximum temperature of less than about 300° C. is preferable, and a maximum temperature of less than about 250° C. is more preferable. As the LVP forms, it precipitates out of solution. Suitable solvents are any polar organic compounds or mixtures of polar organic compounds in which the reaction precursors have a certain solubility and that are thermally stable within the desired temperature range. Examples of suitable solvents include different alcohols, acids, nitrites, amines, amides, quinoline, and pyrrolidinones, etc. and mixture of these solvents. Specific examples include 1-heptanol, propylene carbonate, ethylene carbonate, diethylenetriamine, and NMP (n-methyl-pyrrolidone, 1-methyl-2-pyrrolidinone, or 1-methyl-2-pyrrolidone), and any combination of these solvents. It is preferred that the boiling point of the solvent be at least 20° C. and more preferably above 100° C. The most preferable solvents are polar solvents which have a boiling point greater than that of water and are non-reactive with the precursors. Preferred solvents are also miscible with water. Polar solvents such as NMP, which has a boiling point of 202° C., are most preferred.

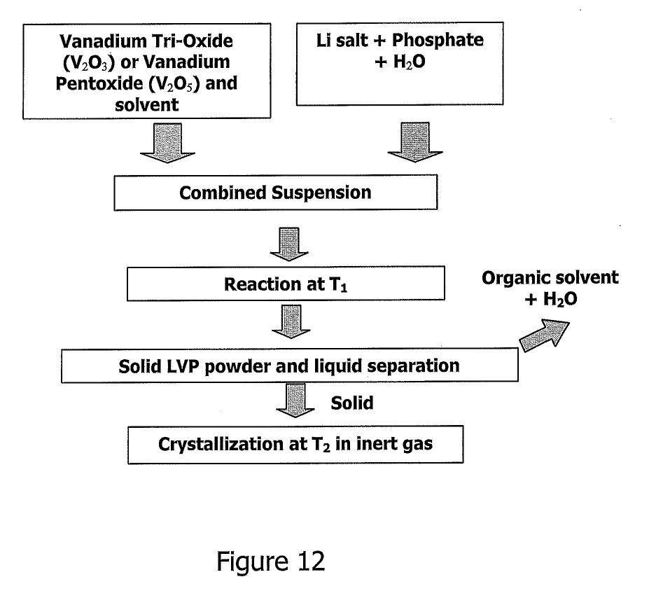

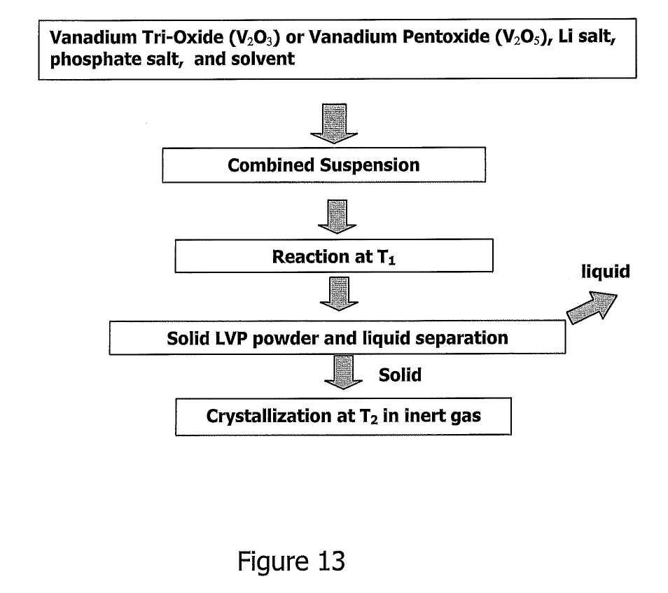

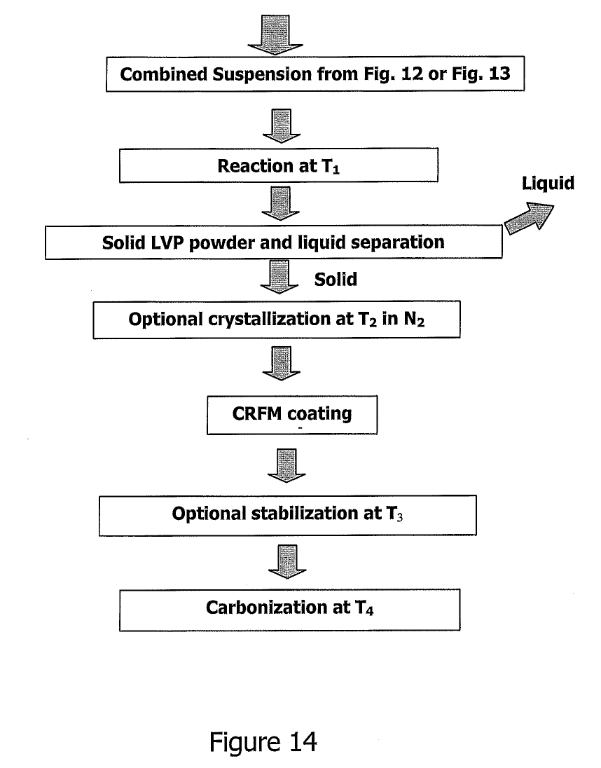

FIG. 12 shows a simple process flow diagram where a suspension is made with vanadium trioxide and a solvent. A first solution is made with a phosphate or other polyanion, a lithium salt and water. The vanadium trioxide suspension and first solution are combined to form a combined suspension. The combined suspension is agitated continuously while being heated to a first temperature, T₁, to drive the reaction to form LVP precipitate.

The preferred precursors for this second basic technique are three valence vanadium trioxide (V₂O₃), five valence vanadium pentoxide (V₂O₅) and ammonium vanadium oxide (NH₃VO₃) powders as the vanadium source. Ammonium vanadium oxide is sometimes described as ammonium metavanadate. Lithium sources include lithium carbonate (Li₂CO₃) or lithium hydroxide (LiOH). Phosphate sources include phosphoric acid (H₃PO₄), but ammonium hydrate phosphate ((NH₄)₂HPO₄) or ammonium phosphate NH₄H₂PO₄ can also be used as the phosphate or polyanion source. There is no specific requirement for the particle size of vanadium oxide powder, but the vanadium trioxide or vanadium pentoxide powder precursor is preferably milled to an average particle size of less than 30 micrometers, and more desirably less than 20 micrometers, to increase the reaction rate. The lithium precursor typically dissolves in the solvent/water solution.

After the precursors and solvent are mixed, the resulting suspension is heated in an inert atmosphere, such as nitrogen, helium, carbon monoxide, or carbon dioxide gas, etc., while the mixture is agitated. The suspension is heated to a temperature (T₁) as high as 400° C., but is preferably below 300° C., even more preferably below 250° C. The heating causes the precursors to react and form the desired compound, Li₃V₂(PO₄)₃, which precipitates out of the solution upon formation. A significant feature of the inventive process is that the presence of the polar solvent prevents the particles of Li₃V₂(PO₄)₃ from growing to a large size and prevents the particles from agglomerating and the Li₃V₂(PO₄)₃ remains as a loose (flowable) powder following separation from the solution.

Any conventional method for solid-liquid separation, such as, for example, centrifugal separation, or filtration, can be used to separate the LVP from the solution. Where the precursor materials are of high quality and contain few or no impurities that would be deleterious to the final product, separation can be achieved by simply evaporating the solvent during the subsequent crystallization step.

Referring back to FIG. 12, the LVP is then subjected to a higher temperature, T₂, to form the desired crystalline structure. The crystallization step involves heating the reacted product at a temperature higher than 400° C. in an inert atmosphere. The heating temperature should be between 400 and 1000° C., and preferably between 500 and 900° C., and more preferably between 500 and 850° C. The resulting product remains as a loose (flowable) powder comprised of at least 99% Li₃V₂(PO₄)₃.

FIG. 13 illustrates a second embodiment of the second technique. In this second embodiment, all of the precursors (vanadium trioxide or vanadium pentoxide, a lithium salt and phosphate) are combined with a solvent, and water as needed, to make a single suspension. The resulting suspension is agitated continuously while being heated to a first temperature, T₁, to drive the reaction to form LVP precipitate. After separation from the suspension the Li₃V₂(PO₄)₃ remains as a powder. The LVP is then subjected to a higher temperature, T₂, to crystallize the LVP. The processes for separating the LVP from the suspension and for crystallizing the LVP prepared according to the second embodiment are the same as the processes for separating and crystallizing the LVP prepared according to the first embodiment.

The component for blending or mixing with the LMO component is not LVP, but rather CLVP. The carbon on the LVP enhances electrical conductivity that is necessary for the lithium intercalation process on the positive electrode side of a lithium-ion battery. Coating the LVP with carbon has several advantages in that it seems to be optimal to have a very thin coating so most of the weight and volume of the CLVP component is the LVP per se. The carbon is present and is important, but does not comprise a significant portion of the mass or volume of the CLVP component. Preferred loading of the carbon on the CLVP is at least 0.1% up to about 10% by weight, preferably between about 0.5% and about 5% by weight, more preferably between about 0.5% and about 3% by weight, and even more preferably between about 1% and about 2.5% by weight.

FIG. 14 provides the later steps of the both processes set forth in FIGS. 12 and 13. The latter steps are to apply the carbon to the crystalline LVP material. Preferably in this second technique, a carbon-residue-forming material (CRFM) is partially or selectively precipitated onto the surface of the LVP particles. A concentrated solution of the CRFM in a suitable solvent is formed by combining the CRFM with a solvent or a combination of solvents to dissolve all or a substantial portion of the CRFM. When petroleum or coal tar pitch is used as the CRFM, preferred solvents are cyclic and aromatic compounds, such as toluene, xylene, quinoline, tetrahydrofuran, tetrahydronaphthalene (sold by DuPont under the trademark Tetralin), or naphthalene, depending on the selected pitch. The ratio of the solvent(s) to the CRFM in the solution and the temperature of the solution are controlled so that the CRFM completely or almost completely dissolves in the solvent. Typically, the solvent to CRFM ratio is less than 2, and preferably about 1 or less, and the CRFM is dissolved in the solvent at a temperature that is below the boiling point of the solvent.

Concentrated solutions wherein the solvent-to-solute ratio is less than 2:1 are commonly known as flux solutions. Many pitch-type materials form concentrated flux solutions wherein the pitch is highly soluble when mixed with the solvent at solvent-to-pitch ratios of 0.5 to 2.0. Dilution of these flux mixtures with the same solvent or a solvent in which the CRFM is less soluble results in partial precipitation of the CRFM. When this dilution and precipitation occurs in the presence of a suspension of LVP particles, the particles act as nucleating sites for the precipitation. The result is an especially uniform coating of the CRFM on the particles.

The coating layer of the LVP particles can be applied by mixing the particles directly into a solution of CRFM. When the LVP particles are added to the solution of CRFM directly, additional solvent(s) is generally added to the resulting mixture to effect partial precipitation of the CRFM. The additional solvent(s) can be the same as or different than the solvent(s) used to prepare the solution of the CRFM.

The coated powder is separated from the solvent and any CRFM remaining in the solvent and dried. The dried coated LVP powder is heated to a temperature of between about 500° C. and about 1000° C., preferably between about 700° C. and about 900° C., more preferably between about 800° C. and about 900° C. to convert the CRFM to carbon. The resulting powder is then described as carbon-coated or carbon-containing LVP or simply CLVP. In this embodiment, the crystallization step at T₂ is optional and may be omitted. Therefore, the heating process at T₄ achieves both conversion of the CRFM to carbon and the crystallization of the LVP. Before the final heat-treatment at T₄, an optional heat-treatment step at T₃, referred to hereinafter as stabilization, may be performed to prevent melting or fusion of coated CRFM.

Other methods of coating the synthesized LVP powder with CRFM may be suitable such as possibly melting or forming a solution with a suitable solvent is combined with a coating step such as spraying the liquefied carbonaceous material onto the LVP particles, or dipping the LVP particles in the liquefied CRFM and subsequently drying out any solvent. Preferred CRFM's are petroleum pitch or coal tar pitch.

In an alternative method to the precipitation method described above, a suspension of LVP particles is prepared by homogeneously mixing the particles in either the same solvent used to form the solution of CRFM, in a combination of solvent(s) or in a different solvent at a desired temperature, preferably below the boiling point of the solvent(s). The suspension of the LVP particles is then combined with the solution of CRFM, causing a certain portion of the CRFM to deposit substantially uniformly on the surface of the LVP particles.

The total amount and chemical composition of the CRFM that precipitates onto the surface of the LVP particles depends on the portion of the CRFM that precipitates out from the solution, which in turn depends on the difference in the solubility of the CRFM in the initial solution and in the final solution. When the CRFM is a pitch, wide ranges of molecular weight species are typically present. One skilled in the art would recognize that partial precipitation of such a material would fractionate the material such that the precipitate would be relatively high molecular weight and have a high melting point, and the remaining solubles would be relatively low molecular weight and have a low melting point compared to the original pitch.

The solubility of the CRFM in a given solvent or solvent mixture depends on a variety of factors including, for example, concentration, temperature, and pressure. As stated earlier, dilution of concentrated flux solutions causes solubility of the CRFM to decrease. Precipitation of the coating is further enhanced by starting the process at an elevated temperature and gradually lowering the temperature during the coating process. The CRFM can be deposited at either ambient or reduced pressure and at a temperature of about −5° C. to about 400° C. By adjusting the total ratio of the solvent to the CRFM and the solution temperature, the total amount and chemical composition of the CRFM precipitated on the LVP particles can be controlled.

By using a liquid phase selective precipitation technique, the total amount, chemical composition, and physical properties of the CRFM coated on the LVP powder may be controlled by the choice of CRFM, by changing the solvent used to initially dissolve the CRFM, by changing the amount of solvent used to initially dissolve the CRFM, and by changing the amount of solvent in the CRFM-LVP mixture. The amount of solvent used may be any amount suitable to provide a desired coating. In certain embodiments, the weight ratio of CRFM to solvent may be between about 0.1 to about 2, alternatively between about 0.05 and about 0.3, or more particularly between about 0.1 and about 0.2.

It is to be understood that the CRFM provided as the coating for the LVP may be any material which, when thermally decomposed in an inert atmosphere to a carbonization temperature of 600° C. or greater temperature forms a residue which is “substantially carbon”. It is to be understood that “substantially carbon” indicates that the residue is at least 95% by weight carbon. Preferred for use as coating materials are CRFM's that are capable of being reacted with an oxidizing agent. Preferred compounds include those with a high melting point and a high carbon yield after thermal decomposition. Without limitation, examples of CRFM's include petroleum pitches and chemical process pitches, coal tar pitches, lignin from pulp industry; and phenolic resins or combinations thereof. In other embodiments, the CRFM may comprise a combination of organic compounds such as acrylonitrile and polyacrylonitriles; acrylic compounds; vinyl compounds; cellulose compounds; and carbohydrate materials such as sugars. Especially preferred for use as coating materials are petroleum and coal tar pitches and lignin that are readily available and have been observed to be effective as CRFM's.

Any suitable solvent may be used to dissolve the carbonaceous material. Without limitation, examples of suitable solvents include xylene, benzene, toluene, tetrahydronaphthalene (sold by DuPont under the trademark Tetralin), decaline, pyridine, quinoline, tetrahydrofuran, naphthalene, acetone, cyclohexane, ether, water, n-methyl-pyrrolidone (NMP), carbon disulfide, or combinations thereof. The solvent may be the same or different than the suspension liquid used to form the LVP powder suspension. Without limitation, examples of liquids suitable for suspension of the LVP powder include xylene, benzene, toluene, tetrahydronaphthalene , decaline, pyridine, quinoline, tetrahydrofuran, naphthalene, acetone, cyclohexane, ether, water, n-methyl-pyrrolidone (NMP), carbon disulfide, or combinations thereof.

It is an optional step for the coated LVP powder to be stabilized after separation from the CRFM-LVP mixture. Such stabilization includes heating the coated LVP powder for a predetermined amount of time in a nearly inert (containing less than 0.5% oxygen) environment. In an embodiment, the coated LVP powder may be stabilized by raising the temperature to between about 20° C. and 400° C., alternatively between about 250° C. and 400° C., and holding the temperature between about 20° C. and 400° C., alternatively between about 250° C. and about 400° C. for 1 millisecond to 24 hours, alternatively between about 5 minutes and about 5 hours, alternatively between about 15 minutes and about 2 hours. The stabilization temperature should not exceed the instantaneous melting point of the carbonaceous material. The exact time required for stabilization will depend on the temperature and the properties of the CRFM coating.

In an alternative embodiment, the coated LVP powder may be heated in the presence of an oxidizing agent. Any suitable oxidizing agent may be used, such as a solid oxidizer, a liquid oxidizer, and/or a gaseous oxidizer. For instance, oxygen and/or air may be used as an oxidizing agent.

The coated LVP powder may then be carbonized. Carbonization may be accomplished by any suitable method. In an embodiment, the coated LVP powder may be carbonized in an inert environment under suitable conditions to convert the coating of CRFM to carbon. Without limitation, suitable conditions include raising the temperature to between about 600° C. and about 1,100° C., alternatively between about 700° C. and about 900° C., and alternatively between about 800° C. and about 900° C. The inert environment may comprise any suitable inert gas including without limitation argon, nitrogen, helium, carbon dioxide, or combinations thereof. Once carbonized, the carbon-coated LVP (CLVP) powders may be used as a material for the positive electrode in lithium ion batteries or for any other suitable use.

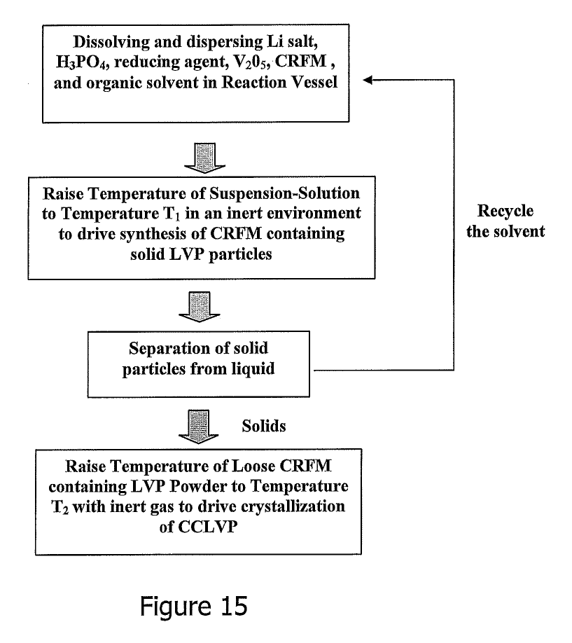

The third and most preferred technique for synthesizing CLVP is by a process that follows the flow diagram illustrated in FIG. 15. The precursors include solid powder vanadium pentoxide (V₂O₅), lithium carbonate (Li₂CO₃), phosphoric acid (H₃PO₄), and N-methyl pyrrolidinone (C₅H₉NO, NMP). The amounts of V₂O₅, Li₂CO₃, and H₃PO₄ should be added strictly according to the stoichiometric ratio V₂O₅, 1.5Li₂CO₃, 3H₃PO₄, with about 3% excess of Li₂CO₃. The amount of NMP can vary from 14 to 17 times the amount of V₂O₅ based on the molar ratio. In addition to the purity, V₂O₅ should be a fine powder consisting of primary particles of less than 10 μm. The concentration of H₃PO₄ should be about 85%.

The precursors are added together by dispersing V₂O₅ in NMP and de-agglomerating as necessary and then adding H₃PO₄ solution into the V₂O₅ solution, while dispersing Li₂CO₃ in NMP and adding the resulting slurry to the V₂O₅ and H₃PO₄ solution.

When mixing the H₃PO₄ and Li₂CO₃ heat is generated and CO₂ gas is simultaneously released. The total amount of the heat is not sufficient to increase the solution by more than 40° C.

In the solution, the V⁵⁺ is reduced to V³⁺ with simultaneous oxidation of NMP and at the same time the precipitation of solid particles that have overall stoichiometric composition close to Li₃V₂(PO₄)₃ when the solution is heated as described below.

The operation should be carried out in a sealed pressure vessel with continuous agitation. The operation temperature should be controlled to be at least 200° C., preferably near 250° C., but no higher than about 280° C. Pressure increases during reaction but it should not excess 350 psi. The solution should be continuously agitated during reaction to ensure homogeneous contact among the reactants and to prevent both the reactant solid V₂O₅ and the product solid from settling on the bottom of the reactor.

The reaction takes more than one hour and preferably about three hours. Under such a reaction condition, the yield of the resulting precipitate solid is nearly 100% of the expected value for Li₃V₂(PO₄)₃ from the added precursors, and the resulting heavy oxidized NMP compounds would have the fixed carbon content of about 27% and yield the total amount of carbon at 2.4% carbon based on total resulting Li₃V₂(PO₄)₃ and carbon solid.

The solution after the reaction consists of solid particles and liquid. The total amount of solid particles is close to the expected value for Li₃V₂(PO₄)₃ from the quantity of the added reactants. The liquid phase consists of NMP, oxidized NMP compounds, water, and possibly some light hydrocarbons resulting from reactions between oxidized NMP and water. The current preferred separation method is evaporation either under reduced pressure or atmospheric pressure at temperatures above the boiling point of NMP. The resulting solid phase consists of two solid components: inorganic solid with a stoichiometric composition close to Li₃V₂(PO₄)₃ and organic compounds. The total amount of the heavy organic compounds is about 9% of the total solid. The heavy organic solid contains about 27% elemental carbon when it is carbonized at 900° C. in nitrogen gas. Therefore, after the solid material is subjected to the carbonization/crystallization step described below, the final resulting powder contains single phase Li₃V₂(PO₄)₃ particles and about 2.4% carbon coating thereon.

A post-treatment step may be required to de-agglomerate the dried solid powder after the solid powder is separated from liquid either by evaporation or by filtration method. De-agglomeration operation can be done by a mechanical method such as high shear blending and shaking with milling media.

After de-agglomeration, the solid powder does not have the desired crystalline structure and conductive carbon. The powder is subjected to carbonization/crystallization step mentioned above where the powder is subjected to a thermal treatment so that the desired crystalline structure of Li₃V₂(PO₄)₃ is formed and heavy hydrocarbon coating (either oxidized NMP products or precipitated pitch) is converted into elemental carbon. The heat treatment must be conducted under non-oxidizing environment such as nitrogen gas. The optimum temperature is about 850° C. and the desired heating time is longer than 6 hours. There is not any requirement for the temperature ramping rate.

To achieve the desired particle size distribution, mechanical processes such as high shear mechanical blending and shaking with grinding medium are used.

### EXAMPLES

Electrochemical tests—Coin cells (standard CR2025 size) were used to evaluate the electrochemical properties of the mixture materials as cathode for lithium ion batteries. The counter electrode in the coin cells was lithium metal foil, and the electrolyte was 1 M LiPF₆ in a solvent mixture (40% ethylene carbonate, 30% dimethyl carbonate, and 30% diethyl carbonate).

All the electrodes were prepared with the following steps: step a) the lithium metal oxide was ground with carbon black and graphite powder with a mortar pestle by hand and then mixed with CLVP, b) the resulting mixture was mixed in the binder solution (n-methyl pyrrolidinone or NMP) to form a slurry, c) the slurry was mixed in a plastic bottle by shaking in a paint mixer for 15 minutes, d) the slurry was cast on a copper foil and then dried on a hot plate for at least 30 minutes, e) the dried films were trimmed into strips of 5 cm in width, and then roll-pressed twice. The dried solid composition was 89% active material (lithium metal oxide and CLVP), 2% carbon black, 4% graphite, and 5% PVDF, and the mass loading was about 8 mg/cm² based on the total mass. Disks of 1.65 cm² were punched out from the pressed films as the electrodes and dried further at 70° C. under vacuum for at least 30 minute before use.

All the cells were cycled at a moderate rate (about 7 hours per cycle) either between 3 and 4.2 volts or between 3.0 and 4.4 volts to determine the capacity and energy efficiency as functions of cycle number.

DSC thermal stability tests—The differential scanning calorimetry (DSC) was used to study the thermal behavior of charged mixture and individual component electrodes. In these experiments, the electrodes were first prepared before DSC test as follows: The electrode were placed in 3-electrode cells and cycled twice between either 3.0 and 4.2 volts or 3.0 and 4.4 volts and then fully charged at constant current to either 4.2 volts or 4.4 volts and further charged at these voltages for one hour or till current dropped to less than 30 μA. The cells were disassembled and the electrodes were removed from the cells. Any excess electrolyte on the electrodes was removed by pressing paper towel (Kimwipe®) on it. The electrodes were then placed in small stainless steel capsules for DSC experiments. All the electrode preparation steps were conducted in a glove box where oxygen gas and moisture levels were less than 5 ppm. In the DSC tests, the samples were heated at the rate of 5° C./m between 30 and 400° C. under nitrogen gas atmosphere and the resulting heat from the sample capsules were recorded.

The CLVP powder used in all the following examples was prepared according to the preferred synthesis method as described above with batch size of 13 kg. A commercial lithium nickel manganese cobalt oxide (LNMC) powder was used as the lithium metal oxide component s in the first examples.

The SEM images of FIGS. 10 and 11 show the cross-section of the LNMC and LNMC-CLVP (1:1) mixture electrodes. The bright particles in FIG. 11 are LMNC particles. Because these electrodes were pressed very hard to achieve a high density, it appears that the particles on the LNMC electrode surface are uniform, consisting of primary particles. The particles on the LNMC-CLVP electrode are not as uniform as that of the LNMC electrode because CLVP particles are much smaller than those of LNMC and CLVP particles take more volume than LNMC particles, LNMC particles would not be broken into primary particles in the mixture. In addition, it can be seen that large LNMC particles are surrounded by small CLVP particles, such a structure would be more stable.

The third column in Table 1 below lists the densities of the electrodes. The density of the LNMC electrodes are significantly higher than those of the LNMC-CLVP mixture electrodes, 3.5 g/cc compared to 2.9 and 2.8 g/cc. The porosities of these electrodes can be estimated to be 14.9, 19.1, and 18.9%, respectively for the electrodes in the order as given in Table 1. Under the same roll-press condition and with the same electrode formulation, the density of the CLVP electrode was 2.2 g/cc, which gives an electrode porosity of 26.4%. Thus, it can be seen that the mixtures of LNMC-CLVP powders are significantly more compressible than the CLVP powder.

TABLE 1
Electrode densities, initial specific capacity and coulombic efficiencies for all
the LNMC-CLVP electrodes

| | | | | 3-4.2 volts | | 3-4.4 volts | |
|---|---|---|---|---|---|---|---|
| | Composition | | | Initial | Coulombic | Initial | Coulombic |
| | (wt %) | | Density | capacity | efficiency | capacity | efficiency |
| Electrode | LNMC | CLVP | (g/cc) | (mAh/g) | (%) | (mAh/g) | (%) |
| LNMC | 100 | 0 | 3.5 | 139.1 | 83.6 | 167.9 | 86.0 |
| LNMC2- | 50 | 50 | 2.8 | 132.3 | 88.7 | 144.4 | 89.0 |
| clvp-b | | | | | | | |
| LNMC2- | 60 | 40 | 2.9 | 134.4 | 87.7 | | |
| clvp-c | | | | | | | |

The specific capacities and coulombic efficiencies of the LNMC-CLVP electrodes are also summarized in Table 1. The initial coulombic efficiency of the LNMC electrodes is relatively low, 83.6% and 86% respectively for the two upper voltage limits, 4.2 and 4.4 volts, compared to 94% or higher for CLVP. Therefore, it is expected that the initial coulombic efficiency increases with CLVP content in the mixture. As shown in Table 1, the LNMC-CLVP (1:1) mixture electrodes yielded an initial coulombic efficiency of 88.7%, 5% better than the LNMC electrodes.

The initial specific capacities of the mixture electrodes are consistent with the values calculated from those of individual components using 125 mAh/g for CLVP, as shown in Table 1. As expected, the LNMC material yielded additional 30 mAh/g when the upper voltage limit was raised to 4.4 volts from 4.2 volts. Thus, a higher voltage limit is preferred for LNMC material if the other components such as electrolyte in the system can stand for a higher voltage. For the LNMC-CLVP (1:1) mixture electrodes, the initial specific capacity was 144.4 mAh/g, or 404.3 mAh/cc, which is better by 47% than that of CLVP electrode (275 mAh/cc).

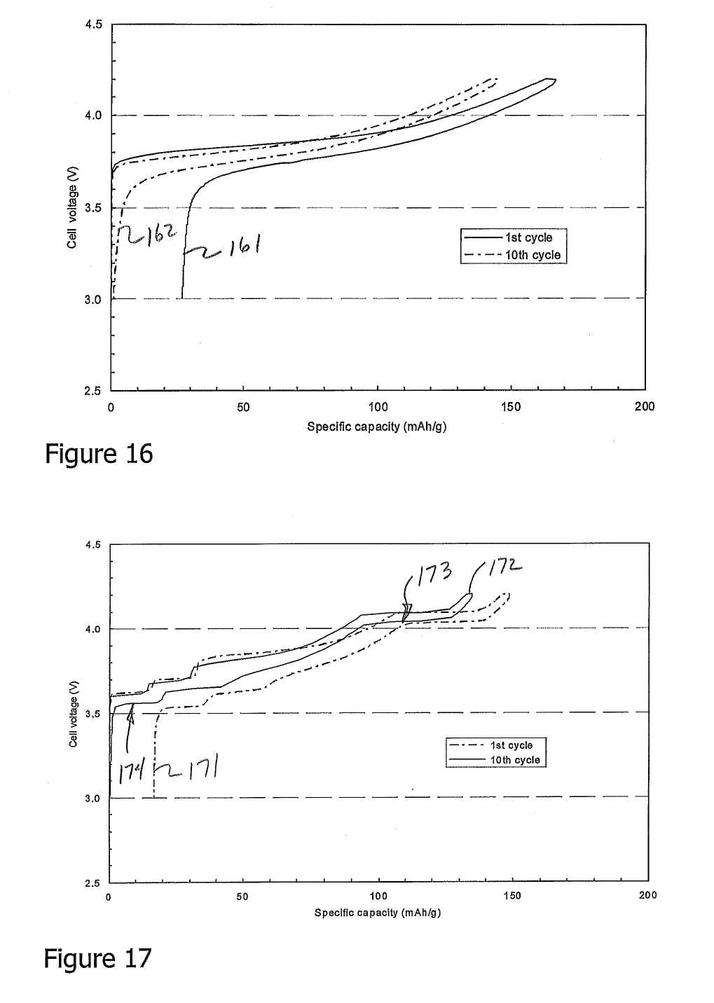

As is known, LNMC powders exhibit an excellent power capability. The example LNMC material also possesses high power capability, as indicated by the very symmetric voltage profiles on charge and discharge in FIG. 16. There is only a small hysteresis in the voltage profile between charge and discharge curves after first cycle indicated by the line 161 and as shown by the line 162 indicating the tenth cycle. For the LNMC-CLVP mixture electrodes, the voltage profiles are also fairly symmetric between charge and discharge, and as expected, have characteristic three plateaus from CLVP materials, as shown in FIG. 17. The first cycle charge voltage profile is identified by the line 171 and the tenth cycle discharge is identified by the line 172. In addition, there is seen an upper plateau near the fully charged end of the specific capacity indicated by the arrow 173 and a lower plateau near the fully discharged end of the specific capacity indicated by the arrow 174. These plateaus are helpful as described above, especially since there is a large specific capacity between these voltage plateaus. For example, it appears from the FIG. 17 that there is about 70 mAh/g of specific capacity between the identified upper and lower voltage plateaus. That is also about fifty percent of the total specific capacity being between the upper and lower plateaus.

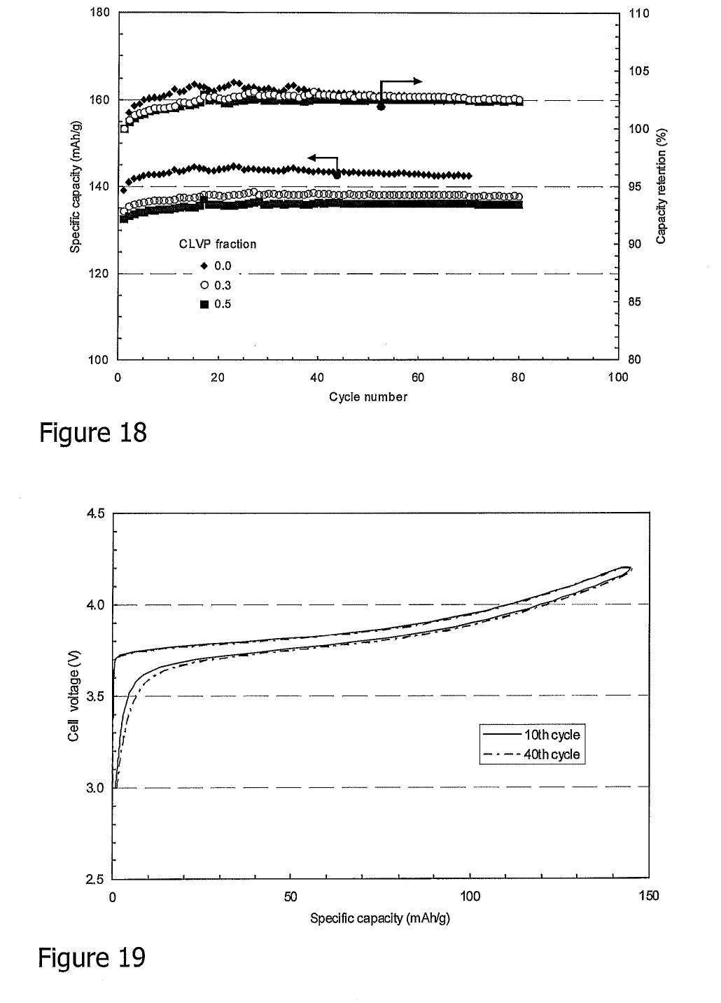

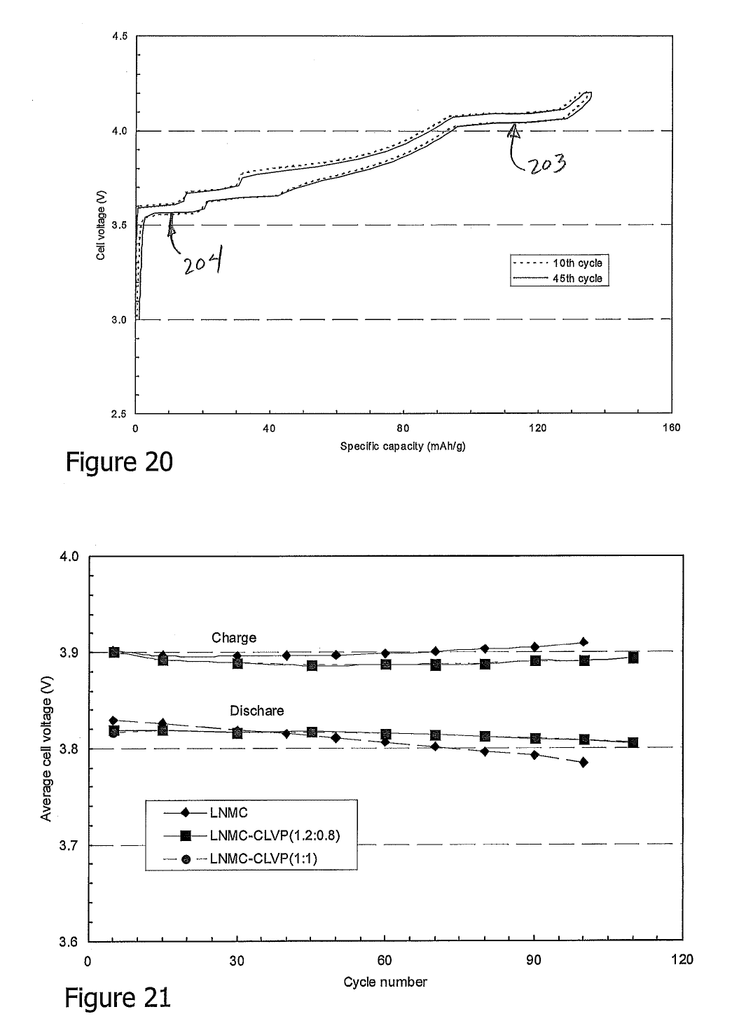

FIG. 18 gives comparison of the specific capacities and capacity retentions at different cycle numbers for the LNMC-CLVP electrodes when these electrodes were cycled between 3 and 4.2 volts. All the electrodes exhibited an excellent cycle life, still having 103% of the initial capacity after 70 cycles. As shown in FIG. 18, the specific capacity of these electrodes increased gradually up to about 50 cycles and then decreased slowly. FIGS. 16 and 18 may indicate that there may not be any benefit with mixtures of LNMC-CLVP powder over LNMC because the LNMC material is so stable and the processes involved on charge and discharge are so reversible within this voltage window (between 3 and 4.2 volts). It should be kept in mind that the specific capacity may remain unchanged even if the voltage profile changes significantly on charge and discharge because the voltage window (3 and 4.2) is much wider than the region where the specific capacity distributes (3.6 and 4.2 volts). However, a change in the voltage profile would affect the energy efficiency on charge and discharge. FIGS. 19 and 20 give comparisons of the voltage profiles between the tenth and the fortieth cycles and tenth and forty-fifth cycles for the LNMC and LNMC-CLVP(1:1) electrodes, respectively. The charge curve remained nearly the same from 10th to 45th cycle, but the discharge curve shifted lower for the LNMC electrode, indicating a small deterioration in the electrode. The upper and lower voltage plateaus are seen again as indicated by the arrows 203 and 204, respectively. The plateaus remained the same while the other portions of the charge and discharge curves became closer from the tenth to the forty-fifth cycles. Thus, the LNMC-CLVP electrodes are seen to be more stable than the LNMC electrodes. Also, the capacity between the plateaus is noted in that it appears to comprise about 70 mAh/g or about 40+% of the total capacity of the cell.

The average cell voltages on charge and discharge as a function of cycle number should be a good indictor for the stability of the cell voltage profiles during cycling. FIG. 21 shows comparison of the average cell voltages at different cycle numbers for the LNMC-CLVP electrodes. As expected, the LNMC electrodes exhibit a smaller gap in the average cell voltage between charge and discharge than the LNMC-CLVP electrodes within a certain number of initial cycles. However, the average cell voltage on discharge decreased continuously with cycle number for the LNMC electrode. On the other hand, the average cell voltages of the LNMC-CLVP electrodes decreased both on charge and discharge, but the gap between charge and discharge became smaller with cycle number. Thus, it can be seen that the LNMC-CLVP mixture electrodes exhibited not only more stable specific capacity but also more stable voltage profiles with cycle number than the LNMC electrodes.

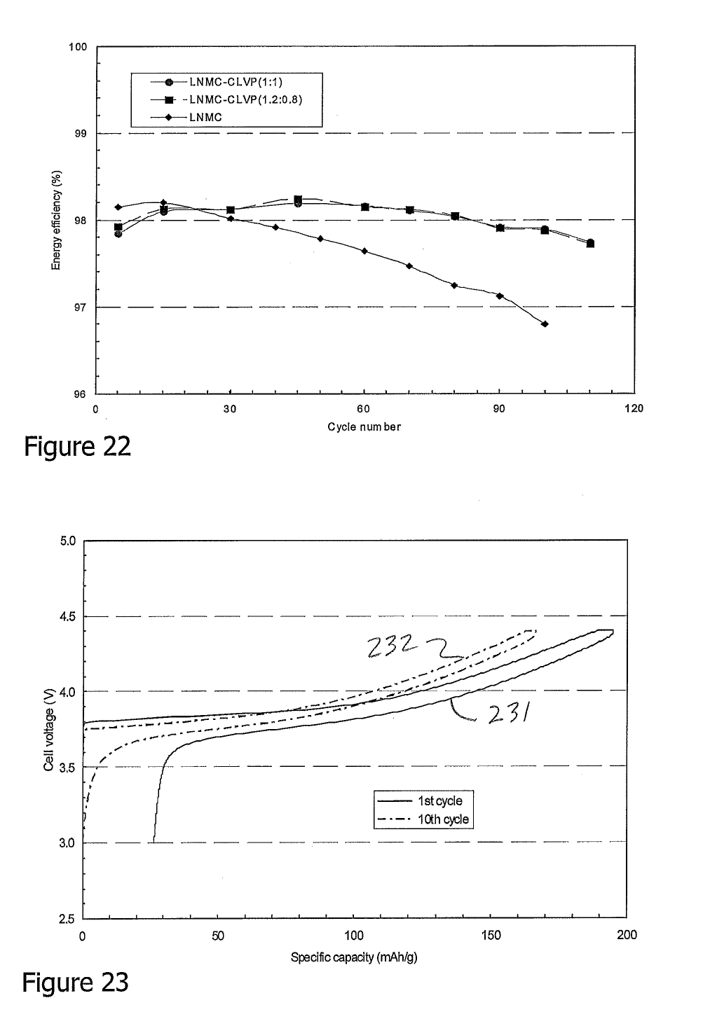

The energy efficiency is the product of the coulombic efficiency and the ratio of the average discharge to charge cell voltages. Because the coulombic efficiency is nearly 100% after a few cycles, the ratio of the average discharge to charge cell voltages is a good representative of energy efficiency. FIG. 22 shows the round-trip energy efficiency as a function of cycle number for the LNMC-CLVP electrodes. Before 20 cycles, the LNMC electrodes yielded better energy efficiency than the LNMC-CLVP electrodes. After 20 cycles, the energy efficiency of the LNMC electrodes dropped below those of the LNMC-CLVP electrodes. Thus, it can be seen that LNMC-CLVP mixture electrodes would have better energy efficiency that LNMC electrodes, which is an important benefit for high power applications.

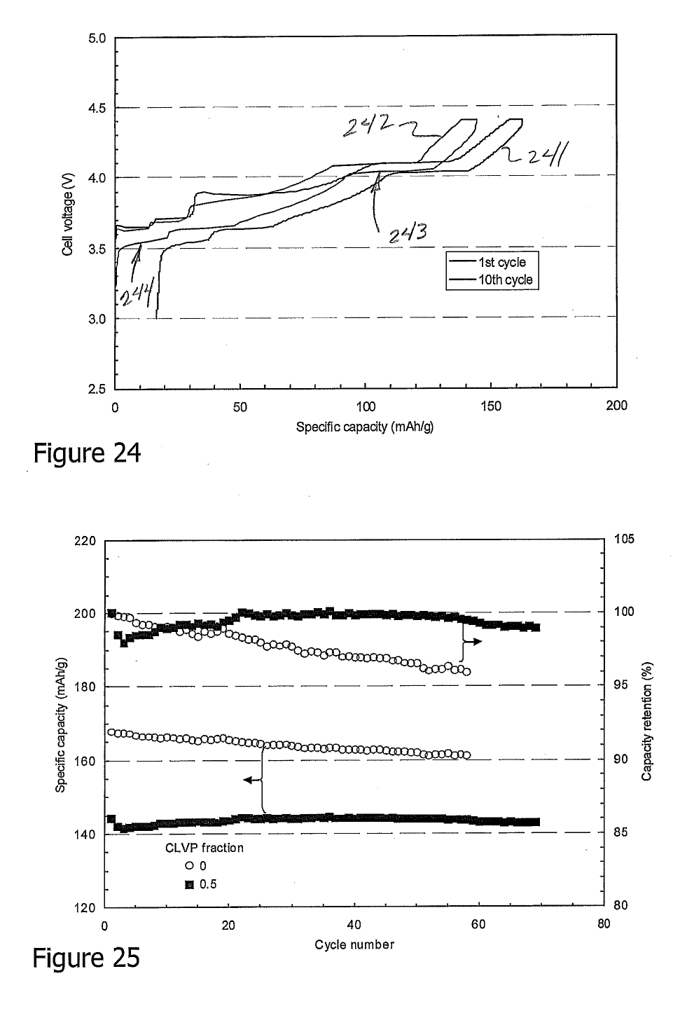

There is not any appreciable change in the voltage profile for the LNMC electrodes when they were cycled between 3 and 4.4 volts compared to those between 3.0 and 4.2 volts, as shown in FIG. 23 where line 231 indicates the first cycle and line 232 indicates the tenth cycle. The cell voltage apparently increases linearly with specific capacity on both charge and discharge. For the LNMC-CLVP electrodes, the voltage profile above 4.1 volts is mainly determined by the LNMC, thus the cell voltage also increases linearly with specific capacity at a stiffer slope, as shown in FIG. 24. The first cycle profile is indicated by the line 241. The upper and lower plateaus are also indicated by the numbers 243 and 244, respectively. Again, the capacity between the plateaus is noted to be substantial, about 60 mAh/g and about 40% of the total capacity of the cell.

FIG. 25 shows comparison of the specific capacities and capacity retentions at different cycle numbers between the LNMC and LNMC-CLVP electrodes when these cells were cycled between 3 and 4.4 volts. The specific capacity of the LNMC electrodes faded gradually with cycle number. However, the LNMC-CLVP(1:1) electrodes showed a drop of 2% from the 1^{st} to 3^{rd} cycle and then gradually gained back 2% over next 20 cycles. Overall, the specific capacity of the LNMC electrodes faded much faster than that of the LNMC-CLVP (1:1) electrodes. Even if the capacity fading rate for the LNMC-CLVP electrodes is normalized to the LNMC content in the LNMC-CLVP electrodes, the normalized fading rate is significantly lower than that of the LNMC electrodes. Thus, the mixture electrodes exhibited better stability than the LNMC electrodes when the electrodes were cycled between 3 and 4.4 volts.

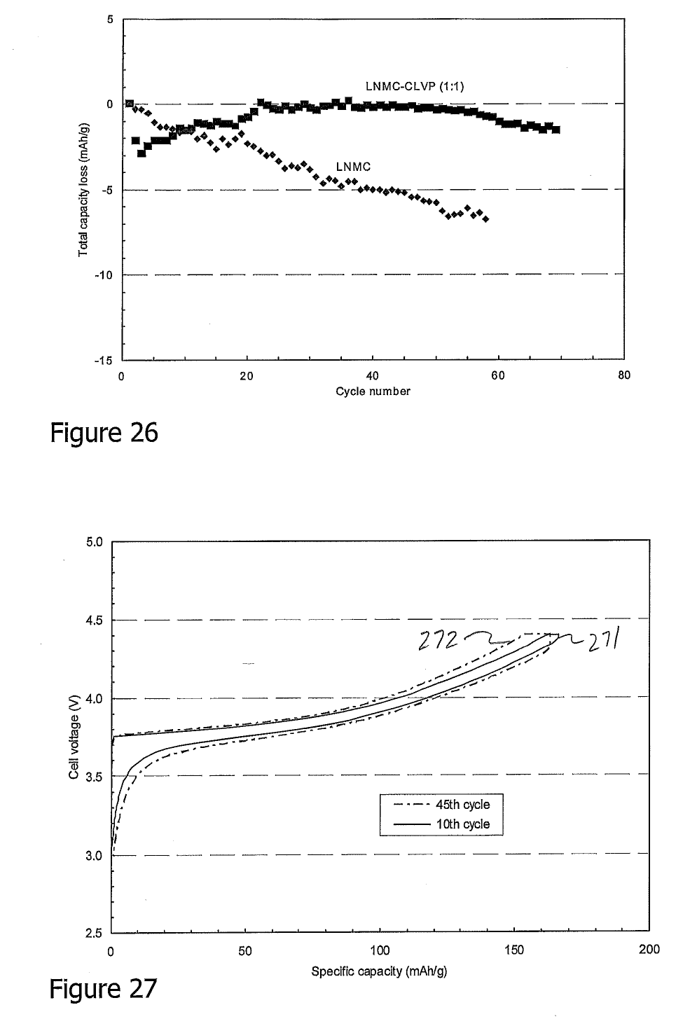

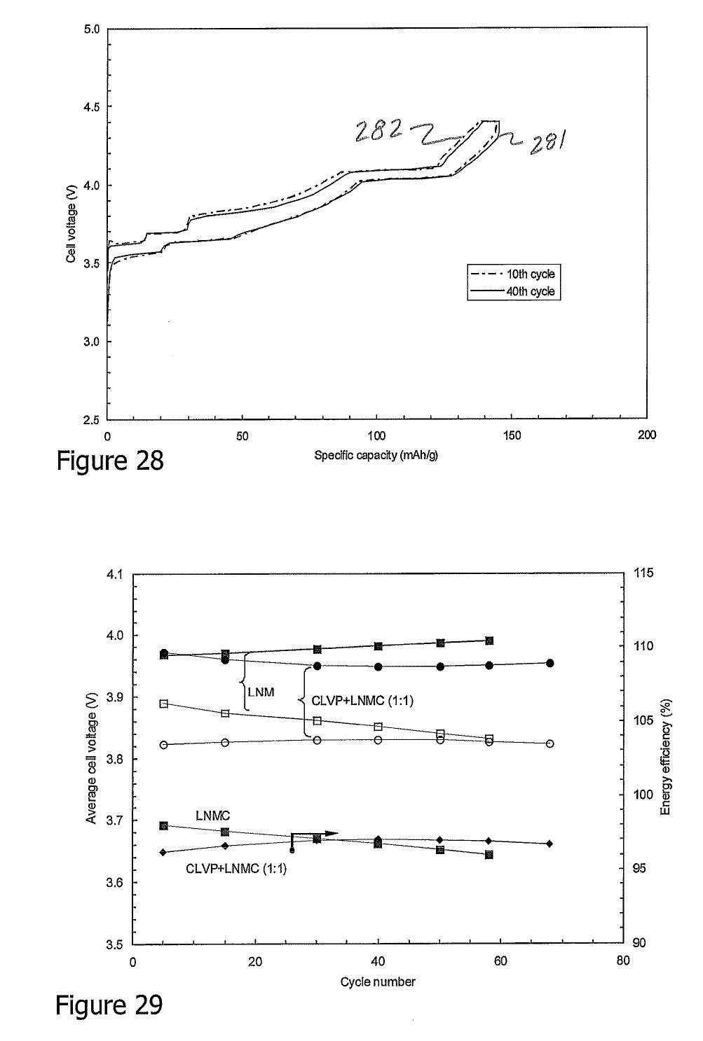

It should be expected that the cell voltage profiles would change to a greater degree when the upper voltage limit was raised to 4.4 volts compared to those for the voltage limit of 4.2 volts. FIGS. 26 and 27 give comparison of the cell voltage profiles between 10^{th} and 45^{th} cycles for the LNMC and LNMC-CLVP(1:1) electrodes, respectively. The cell voltage shifted higher on charge and lower on discharge for the LNMC electrodes, resulting in a larger hysteresis between charge and discharge from tenth cycle indicated by the line 271 to the fortieth cycle as indicated by the number 272. For the LNMC-CLVP electrodes, the hysteresis between charge and discharge became smaller from the tenth cycle indicated by the line 281 to the fortieth cycle as indicated by the number 282. Again, the capacity between the plateaus appears to be about 70 mAh/g and comprises a little less than 50% of the total capacity of the cell.

FIG. 29 showed the average cell voltages on charge and discharge and energy efficiency as function of cycle number for the LNMC-CLVP electrodes. As expected from FIG. 27, the average cell voltage drifted higher on charge and dropped on discharge with cycle number for the LNMC electrodes, whereas it decreased on charge and shifted higher on discharge with cycle number for the LNMC-CLVP electrodes. Correspondingly, the energy efficiency decreased with cycle number for the LNMC electrodes, whereas it increased initially with cycle number and then decreased slowly for the LNMC-CLVP(1:1) electrodes.

Thus, there are several benefits for using mixtures of LNMC-CLVP powders as cathode materials over either LNMC or CLVP powders for high power lithium ion batteries: a) significant better volumetric capacity than pure CLVP and b) better cycle life and energy efficiency than pure LNMC.

Table 1 summarizes the sample weights, the specific capacities and coulombic efficiency on the conditioning cycles, the final charged capacities, and the open-circuit voltage after the final charge for all the samples used in DSC experiments. The values of the specific capacity and coulombic efficiency are consistent with those from coin cells. But it is interesting to note that the open-circuit voltage of the LNMC-CLVP electrodes was lower by 18 and 20 mV than those of the LNMC electrodes even though both the electrodes were charged under the same condition to the same voltages, 4.2 and 4.4 volts respectively. The open-circuit voltages of the CLVP electrodes were even much lower, which may be the reason why the mixture electrodes showed a lower open-circuit voltage than the LNMC electrodes.

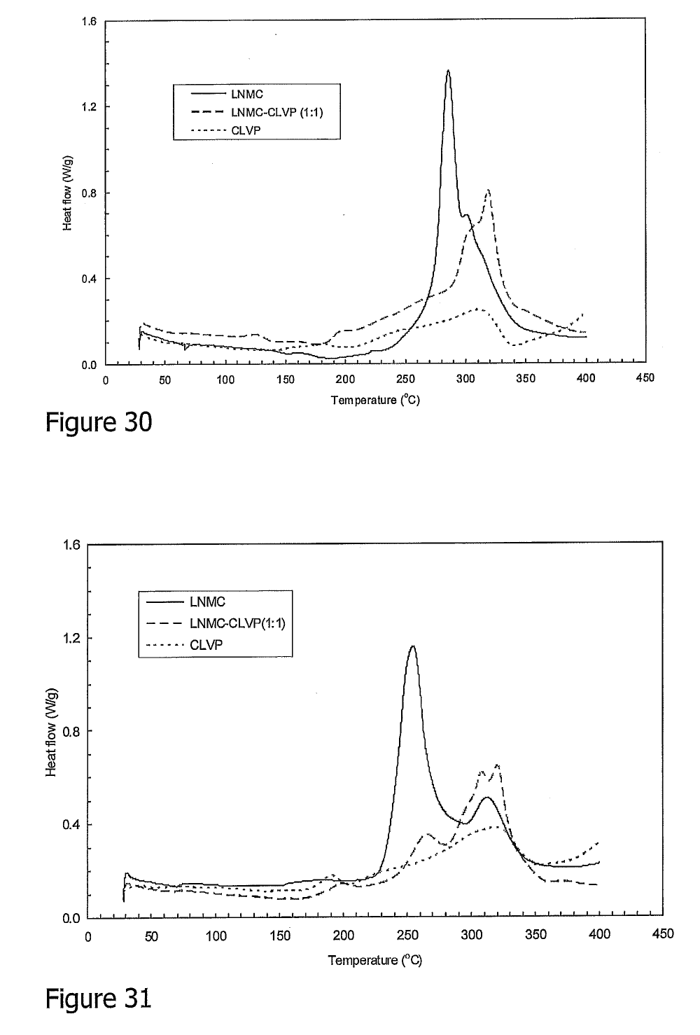

FIG. 30 shows comparison of the DSC profiles for the LNMC, LNMC-CLVP(1:1), and CLVP electrodes that were pre-charged to 4.2 volts. As tested in previous experiments, the CLVP sample exhibited a small exothermic heat within the temperature range. The LNMC samples exhibited a rapid exothermic reaction once the reaction starts because the exothermic heat increased rapidly with temperature and form a sharp peak. For the LNMC-CLVP(1:1) samples, the exothermic heat started near 180° C. and gradually increased with temperature till 285° C. and then rapidly rose to form a small peak.

Because the CLVP material yielded a small amount of heat, it is expected that the exothermic heat from the LNMC-CLVP(1:1) electrodes would be smaller than that from the CLVP electrode at temperatures below 250° C. However, it was surprising to see that the area under the exothermic peak for the LNMC-CLVP(1:1) is not smaller than that of the CLVP or LNMC electrodes. It would be discussed later that the amount of electrolyte may play an important role in the total exothermic heat.

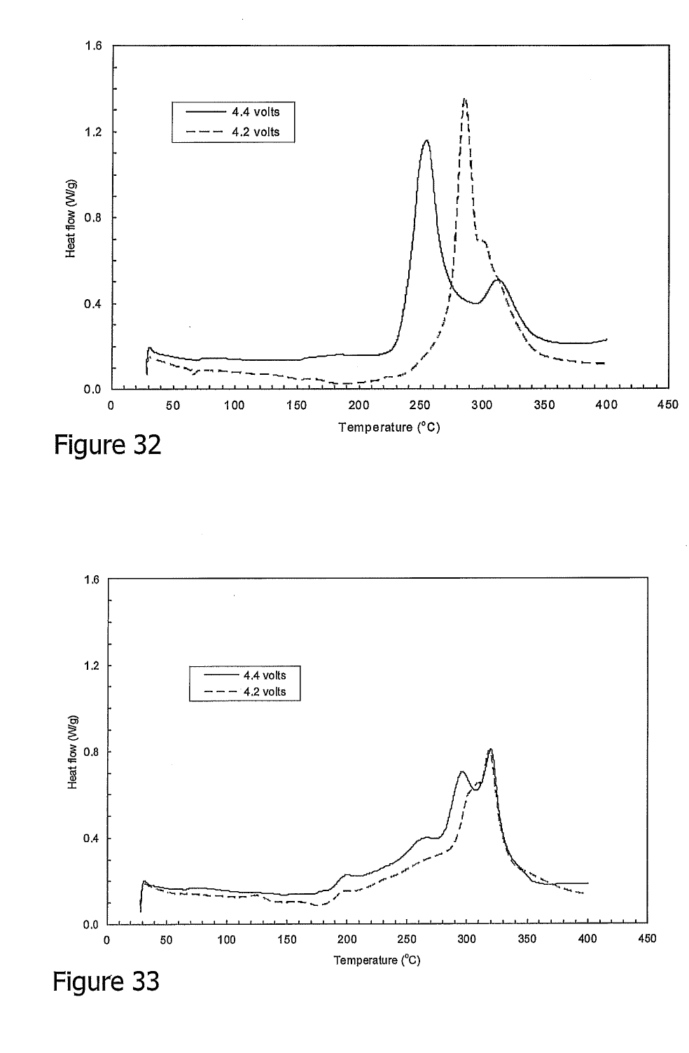

FIG. 31 shows comparison of the DSC profiles for the LNMC and LNMC-CLVP electrodes that were charged to 4.4 volts. Compared with the DSC profiles in FIG. 30, the onset temperature for the exothermic reaction shifted significantly lower for the LNMC electrodes, but there is not much difference for the LNMC-CLVP electrodes. FIGS. 17 and 18 show the comparisons of the DSC profiles for the LNMC and LNMC-CLVP electrodes that were charged to 4.2 and 4.4 volts. It should be mentioned that the DSC profiles in both FIGS. 32 and 33 were such selected that the samples contained near same mount of electrolyte because the amount of electrolyte has a significant effect on the magnitude of the exothermic heat.

If the catastrophic onset temperature is defined as the temperature where large exothermic reaction heat starts to rapidly emit, the onset temperature is near 230° C. for the charged LNMC electrodes and 280° C. for the charged LNMC-CLVP electrodes. Comparing the DSC profiles between FIGS. 32 and 33, it can be seen that the LNMC-CLVP electrodes yielded less heat than the LNMC electrodes.

It is known that the electrolyte salt decomposes at temperatures of higher than 200° C., emitting heat and that the thermal decomposition of charged LNMC material results in oxygen gas that subsequently reacts with electrolyte solvent to generate heat. Therefore, even to qualitatively compare the total exothermic heats for these LNMC and LNMC-CLVP(1:1) electrodes, the amount of electrolyte in each electrode has to be taken into account.

TABLE 2
List of total accumulated exothermic heat at three temperatures
for all the samples.

| | | Total heat (J/g) | | |
|---|---|---|---|---|
| Sample | Description | 250° C. | 300° C. | 400° C. |
| LNMC-CLVP (1:1) | Charged to 4.2 volts | 72 | 222 | 520 |
| LNMC | | 22 | 359 | 626 |
| LNMC-CLVP(1:1) | Charged to 4.4 volts | 56 | 216 | 472 |
| LNMC | | 126 | 424 | 615 |
| CLVP | Charged to 4.2 volts | 42 | 115 | 229 |
| CLVP | Charged to 4.4 volts | 56 | 155 | 365 |

As shown Table 2, the total heats at 250° C. are small for the LNMC-CLVP (1:1) and CLVP electrode regardless of the voltage that these electrodes were charged to, but the total heat doubled to 126 J/g for the LNMC samples when the LNMC electrodes were charged to 4.4 volts. For the samples that were charged to 4.2 volts at 300° C., the LNMC samples yielded 359 J/g whereas the LNMC-CLVP(1:1) had 222 J/g. However those charged to 4.4 volts, the heats increased to 424 J/g and 216 J/g for the LNMC and LNMC-CLVP(1:1) samples, respectively. Thus, the LNMC-CLVP(1:1) electrodes yielded less heat than the LNMC electrodes by 49%. At 400° C., the difference in the total heat between the samples charged to 4.2 and 4.4 volts is insignificant regardless of LNMC and LNMC-CLVP(1:1) sample possibly because the amount of electrolyte in the electrodes may play an important role in determining the total heat for a given material. Nevertheless, the LNMC-CLVP(1:1) samples yielded less heat than the LNMC samples by about 100 J/g. As described above, the LNMC-CLVP (1:1) electrodes were more porous than the LNMC electrodes, the LNMC-CLVP(1:1) samples contained more electrolyte than the LNMC samples, it is expected that LNMC-CLVP(1:1) samples would yield less heat by 150 J/g than the LNMC samples if they are compared for the same electrolyte content.

Thus, the above DSC data show two benefits with mixtures of LNMC and CLVP powders over LNMC powder: 1) the onset temperature for catastrophic thermal runaway would be higher by 50° C. and 2) the total exothermic heat can be reduced by at least 30%.

The two LiNi_{0.8}Co_{0.2}O₂ (LNCO) powders for the Examples were synthesized as follows: The precursors were Ni(OH)₂, LiNO₃, and LiCoO₂. The precursors were mixed with the desired stoichiometric composition and ground by ball-milling. The resulting mixtures were placed in a tube furnace and heated in nitrogen gas environment with the following sequences: at 300° C. for 2 hours, 400° C. for 2 hours, and 600° C. for 12 hours. After the powders were cooled to ambient temperature, they were ground by ball-milling, placed back into the furnace, and heated at 610° C. in nitrogen gas for 15 hours. The resulting powders were further heated in air with some variations for different batches: at 675° C. for 15 hours for the first LiNi_{0.8}Co₂O₂ powder, and at 700° C. for 15 hours for the second LiNi_{0.8}Co₂O₂ powder. After the heat treatment in air, the powders were ground with a mortar and pestle before use.

An example of LiNiO₂ and CLVP powders was developed where the LiNiO₂ powder used was synthesized by solid state reaction in air at 675° C. using nickel hydroxide and lithium nitrate. Similar results in cycle life and efficiency were seen with this blend.

The two LiNi_{0.8}Co_{0.2}O₂ (LNCO) powders synthesized for this study exhibited a reasonably good specific capacity, thus they were used with the same CLVP. Four sets of the LNCO and LNCO-CLVP electrodes were made and evaluated with the first LNCO, and only two sets of the LNCO and LNCO-CLVP electrodes were made with the second LNCO.

Table 3, below, lists the electrode densities and initial specific capacities and coulombic efficiencies for the four sets of the electrodes with different CLVP contents. The density decreases with the CLVP content, but is still significantly higher than that of a CLVP electrode. The initial coulombic efficiency for the LNCO material is relatively low at 82%, as a result, the initial coulombic efficiency increased with the CLVP content. This LNCO material has a reasonably good initial specific capacity at 170 mAh/g. Compared to a CLVP electrode, the LNCO-CLVP mixture electrodes have a significantly higher volumetric capacity. For example, the LNCO-CLVP (1:1) electrode has a volumetric specific capacity of 377 mAh/cc (144.3 mAh/g at 2.61 g/cc), compared to about 260 mAh/cc (124 mAh/g at 2.1 g/cc), which is higher by 45% than that of a CLVP electrode.

TABLE 3

| | | | | |
|---|---|---|---|---|
| | | | Specific | |
| | CLVP | density | capacity | Coulombic |
| Electrode | fraction | (g/cc) | (mAh/g) | efficiency (%) |

| | | | | |
|---|---|---|---|---|
| LNCO | 0 | 3.24 | 170.3 | 82.0 |
| LNCO-clvp-a | 0.4 | 2.81 | 151.4 | 86.4 |
| LNCO-clvp-b | 0.5 | 2.61 | 144.3 | 86.9 |
| LNCO-clvp-c | 0.6 | 2.56 | 140.1 | 88.2 |

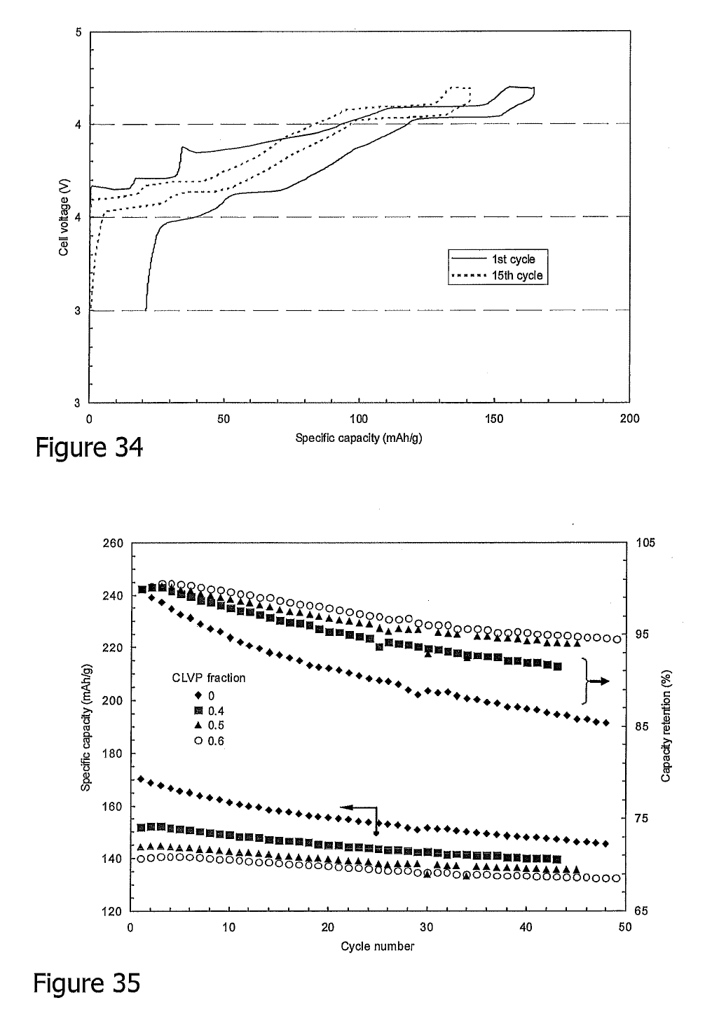

FIG. 34 shows comparison of the cell voltage profiles between the 1^{st} and 15^{th} cycles for LNCO-CLVP electrodes, the cell voltage profiles on the first cycle were asymmetric between charge and discharge, but became very symmetric after a few cycles. Thus, it is expected that the LNCO-CLVP electrodes would have a good power capability or energy efficiency after a few cycles.

Table 4 lists the calculated average cell voltages and round-trip energy efficiencies at the 5^{th} and 15^{th} cycles for the LNCO and LNCO-CLVP electrodes. The cell voltage gap between charge and discharge is about 80 mV on the 5^{th} cycle. From 5^{th} cycle to 15^{th} cycle, the energy efficiency drops appreciably by 0.8% for the LNCO electrodes, but much less for the LNCO-CLVP electrode, indicating that the LNCO-CLVP electrodes are more stable than the LNCO electrode.

TABLE 4

| | | 5th cycle | | | 15th cycle | | |
|---|---|---|---|---|---|---|---|
| | | Average cell | | Energy | Average cell | | Energy |
| | CLVP | voltage (V) | | efficiency | voltage (V) | | efficiency |
| Electrode | fraction | Charge | Discharge | (%) | Charge | Discharge | (%) |
| LNCO | 0 | 3.905 | 3.825 | 97.96 | 3.914 | 3.801 | 97.13 |
| LNCO-clvp-a | 0.4 | 3.896 | 3.815 | 97.91 | 3.900 | 3.800 | 97.44 |
| LNCO-clvp-b | 0.5 | 3.891 | 3.812 | 97.96 | 3.893 | 3.801 | 97.64 |
| LNCO-clvp-c | 0.6 | 3.893 | 3.808 | 97.82 | 3.893 | 3.801 | 97.63 |

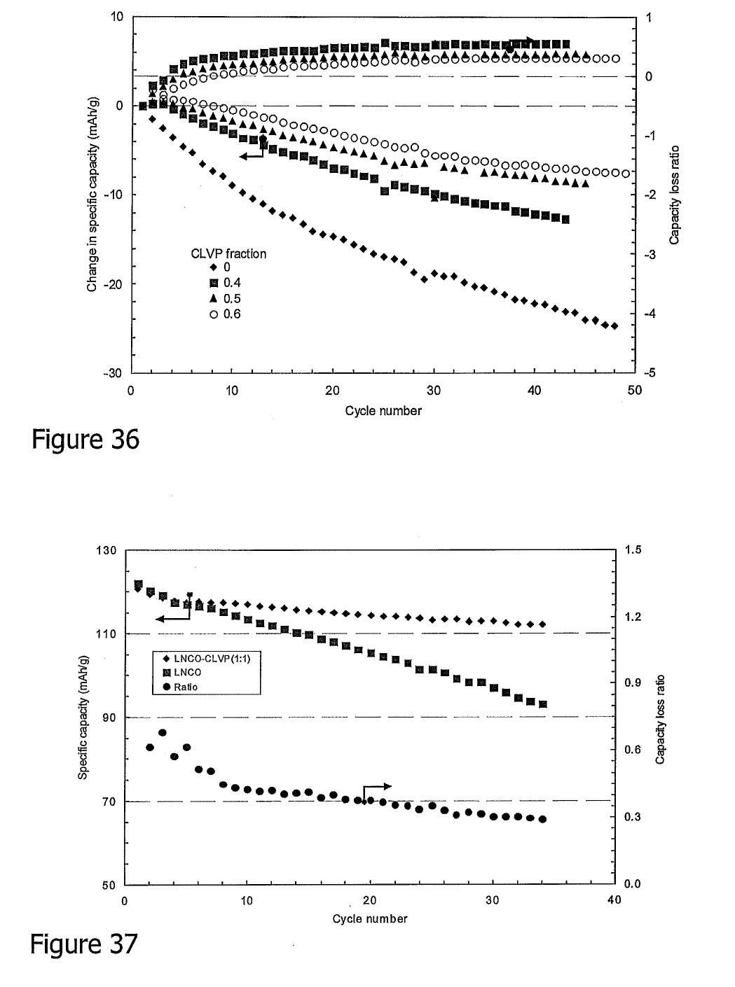

FIGS. 35 and 36 present the cycle life behavior of these electrodes. As the CLVP content was increased, the capacity loss decreased and the capacity retention increased, as shown in FIG. 36. After 50 cycles, the LNCO electrode lost about 15% of the initial capacity, whereas the LNCO-CLVP electrodes lost a significantly less capacity, depending on the CLVP content. For example, the LNCO-CLVP (1:1) electrode lost less than 7%.

The second LNCO powder exhibited a lower specific capacity (122 mAh/g) and also a lower initial coulombic efficiency (72%) than the first LNCO powder possibly due to the heat-treatment at a higher temperature (700° C. vs. 675° C.). FIG. 38 shows the specific capacities and the capacity loss ratio at different cycle numbers for this LNCO and LNCO-CLVP(1:1) electrodes. It can be seen that the capacity of this LNCO material faded relatively fast with cycle number, whereas the capacity of the CLVP mixture electrodes with this material faded much slower. Even though the capacity loss ratio is greater than the fraction of LNCO in the mixture electrode (0.5) at the beginning cycles, the ratio decreased continuously and dropped to below 0.3 after about 30 cycles. Thus, it can be seen that the capacity fading rate of the LNCO in the LNCO-CLVP mixture electrodes was reduced by about 40%.

The above experimental results have clearly shown that mixtures of CLVP and lithium metal oxide powder have many advantages over individual materials as cathode material for lithium-ion batteries and that CLVP is so robust that it can be designed with many other lithium metal oxides for a wide operating voltage window. While considerable effort has been put into the development of the many chemistries and also into producing highly pure forms of the cathode materials to reduce dilution by inactive materials, the inventors have investigated combining powders having different chemical make-ups looking for optimal balancing of properties and performance characteristics.

Accordingly, the scope of protection is not limited by the description set out above, but is only limited by the claims which follow, that scope including all equivalents of the subject matter of the claims. Each and every claim is incorporated into the specification as an embodiment of the present invention. Thus the claims are a further description and are an addition to the preferred embodiments of the present invention. The discussion of any reference is not an admission that it is prior art to the present invention, especially any reference that may have a publication date after the priority date of this application.

1. A lithium based cathode battery powder for rechargeable lithium-ion batteries wherein the powder comprises:
a) a mixture of at least two different powders wherein a first powder comprises a carbon-containing lithium transition metal poly-anion; and
b) a second powder comprising lithium transition-metal oxide, wherein the transition metal is selected from the group including scandium, titanium, vanadium, chromium, manganese, iron, cobalt, nickel, copper, zinc or a combination thereof.

2. The lithium based cathode battery powder according to claim 1 wherein the second powder has the chemical formula LiMO₂ wherein M is at least one first row transition metal.

3. The lithium based cathode battery powder according to claim 1 wherein the carbon-containing lithium transition metal poly-anion is a carbon-containing lithium transition metal phosphate.

4. The lithium based cathode battery powder according to claim 1 wherein the carbon-containing lithium transition metal poly-anion is a carbon-containing lithium vanadium phosphate where the lithium vanadium phosphate has the stoichiometric chemical formula Li₃V₂(PO₄)₃.

5. The lithium based cathode powder according to claim 4 wherein the lithium based cathode battery powder comprises at least ten percent and no more than ninety percent by weight of the carbon-containing lithium vanadium phosphate powder.

6. The lithium based cathode powder according to claim 5 wherein the remaining portion of the lithium based cathode battery powder substantially comprises one or more lithium transition metal oxides.

7. The lithium based cathode powder according to claim 4 wherein the lithium based cathode battery powder comprises at least twenty percent and no more than eighty percent by weight of the carbon containing lithium vanadium phosphate powder.

8. The lithium based cathode powder according to claim 7 wherein the remaining portion of the lithium based cathode battery powder substantially comprises one or more lithium transition metal oxides.

9. The lithium based cathode powder according to claim 4 wherein the lithium based cathode battery powder comprises at least thirty percent and no more than seventy percent by weight of the carbon containing lithium vanadium phosphate powder.

10. The lithium based cathode powder according to claim 9 wherein the remaining portion of the lithium based cathode battery powder substantially comprises one or more lithium transition metal oxides.

11. The lithium based cathode powder according to claim 4 wherein the lithium based cathode battery powder comprises at least forty percent and no more than sixty percent by weight of the carbon containing lithium vanadium phosphate powder.

12. The lithium based cathode powder according to claim 11 wherein the remaining portion of the lithium based cathode battery powder substantially comprises one or more lithium transition metal oxides.

13. The lithium based cathode powder according to claim 4 wherein the second powder comprises at least manganese.

14. The lithium based cathode powder according to claim 4 wherein the second powder comprises at least cobalt.

15. The lithium based cathode powder according to claim 4 wherein the second powder comprises at least nickel.

16. The lithium based cathode powder according to claim 4 wherein the first powder comprises between 0.1 and 10 percent carbon.

17. The lithium based cathode powder according to claim 4 wherein the first powder comprises between 0.5 and 3 percent carbon.

18. A rechargeable lithium-ion battery having a cathode material comprising:
a) a mixture of at least two different powders wherein a first powder comprises a carbon-containing lithium vanadium phosphate where the lithium vanadium phosphate has the stoichiometric chemical formula Li₃V₂(PO₄)₃,
b) and the second powder comprises a lithium transition metal oxide, wherein the transition metal comprises one or more first row transition metals.

19. A rechargeable lithium-ion cell having at least two voltage plateaus wherein an upper voltage plateau is near the fully charged state and a lower plateau is near the fully discharged state and where at least 30% of the charge capacity of the cell exists between the upper and lower voltage plateaus.

20. The rechargeable lithium-ion cell according to claim 17 wherein at least 35% of the charge capacity is between the upper and lower voltage plateaus.

21. The rechargeable lithium-ion cell according to claim 18 wherein at least 40% of the charge capacity is between the upper and lower voltage plateaus.

22. A rechargeable lithium-ion cell having at least two voltage plateaus wherein an upper voltage plateau is near the fully charged state and a lower plateau is near the fully discharged state and where at least 40 mAb/g of charge capacity of the cell exists between the upper and lower voltage plateaus.

23. The rechargeable lithium-ion cell according to claim 20 wherein at least 50 mAh/g exists between the upper and lower voltage plateaus.

24. A rechargeable lithium-ion battery comprising a cathode and an anode wherein the cathode comprises a composition of particles having at least two different chemical make-ups, where a first set of particles comprises a carbon containing lithium transition metal poly-anion and a second set of particles comprises a lithium transition metal oxide where the transition metals for both sets of particles is selected from the group including scandium, titanium, vanadium, chromium, manganese, iron, cobalt, nickel, copper, zinc or a combination thereof, and where the first and second sets of particles are blended or dispersed throughout the cathode.

25. The rechargeable lithium-ion battery wherein the first set of particles is carbon containing lithium vanadium phosphate.
